(19) United States
(12) Patent Application Publication
(10) Pub. No.: US 2026/0074769 A1
(43) Pub. Date: Mar. 12, 2026

(54) UE-DRIVEN SEQUENTIAL TRAINING

(71) Applicant: QUALCOMM Incorporated, San Diego, CA (US)

(72) Inventors: Abdelrahman Mohamed Ahmed Mohamed Ibrahim, San Diego, CA (US); June Namgoong, San Diego, CA (US); Taesang Yoo, San Diego, CA (US); Naga Bhushan, San Diego, CA (US); Jay Kumar Sundararajan, San Diego, CA (US); Chenxi Hao, Beijing (CN); Runxin Wang, San Diego, CA (US); Tingfang Ji, San Diego, CA (US)

(21) Appl. No.: 18/873,221

(22) PCT Filed: Mar. 6, 2023
(86) PCT No.: PCT/CN2023/079741

§ 371 Date: Dec. 9, 2024

(30) Foreign Application Priority Data
Aug. 12, 2022 (WO) PCT/CN2022/112155

(51) Int. Cl. H04B 7/06; H04W 24/02

(52) U.S. Cl. CPC H04B 7/0658; H04W 24/02

(57) ABSTRACT

This disclosure provides systems, methods, and devices for wireless communication that support UE-driven sequential training. In a first aspect, a method of wireless communication includes obtaining channel state information data associated with a second network node; training a shared UE encoder based on the channel state information data and based on a decoder to generate a sequential training dataset; and transmitting the sequential training dataset to a third network node. Other aspects and features are also claimed and described.

### CROSS-REFERENCE TO RELATED APPLICATIONS

This application claims the benefit of International Patent Application No. PCT/CN2022/112155, entitled, “UE-DRIVEN SEQUENTIAL TRAINING,” filed on Aug. 12, 2022, which is expressly incorporated by reference herein in its entirety.

### TECHNICAL FIELD

Aspects of the present disclosure relate generally to wireless communication systems, and more particularly, to sequential training for encoding and decoding. Some features may enable and provide improved communications, including the generation of shared or universal encoders and decoders for cross-node channel state feedback.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, an apparatus includes at least one processor and a memory coupled to the at least one processor. The at least one processor is configured to obtain channel state information data associated with a second network node; train a shared UE encoder based on the channel state information data and based on a decoder to generate a sequential training dataset; and transmit the sequential training dataset to a third network node.

In an additional aspect of the disclosure, an apparatus includes at least one processor and a memory coupled to the at least one processor. The at least one processor is configured to receive a sequential training dataset from a second network node; train a base station decoder based on the sequential training dataset to generate decoder model information; and transmit the decoder model information for the base station decoder to a third network node.

In an additional aspect of the disclosure, an apparatus includes at least one processor and a memory coupled to the at least one processor. The at least one processor is configured to transmit channel state information data to a second network node; receive encoder model information from the second network node, the encoder model information based on the channel state information; and transmit data to a third network node by encoding the data based on the encoder model information.

In an additional aspect of the disclosure, an apparatus includes at least one processor and a memory coupled to the at least one processor. The at least one processor is configured to receive decoder model information for a shared base station decoder from a second network node; and receive encoded data from a third network node by decoding the encoded data based on the shared base station decoder.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3A is a block diagram illustrating an example of encoder decoder operations for channel state feedback according to one or more aspects.

FIG. 3B is a block diagram illustrating an example of concurrent training according to one or more aspects.

FIG. 3C is a block diagram illustrating an example of sequential training according to one or more aspects.

FIG. 4 is a block diagram illustrating an example wireless communication system that supports UE-driven sequential training according to one or more aspects.

FIG. 5 is a timing diagram illustrating an example wireless communication system that supports UE-driven sequential training according to one or more aspects.

FIG. 6 is a timing diagram illustrating an example wireless communication system that supports UE-driven sequential training according to one or more aspects.

FIG. 7 is a timing diagram illustrating an example wireless communication system that supports UE-driven sequential training according to one or more aspects.

FIG. 8A is a block diagram illustrating an example of sequential training with reference decoders according to one or more aspects.

FIG. 8B is a block diagram illustrating an example of a decoder with preprocessing according to one or more aspects.

FIG. 9A is a block diagram illustrating an example of a decoder with preprocessing according to one or more aspects.

FIG. 9B is a block diagram illustrating an example of a decoder with preprocessing according to one or more aspects.

FIG. 9C is a block diagram illustrating an example of a decoder with preprocessing according to one or more aspects.

FIG. 9D is a block diagram illustrating an example of common preprocessing layers of a decoder according to one or more aspects.

FIG. 9E is a block diagram illustrating an example of a split-architecture decoder according to one or more aspects.

FIG. 10 is a flow diagram illustrating an example process that supports UE-driven sequential training according to one or more aspects.

FIG. 11 is a flow diagram illustrating an example process that supports UE-driven sequential training according to one or more aspects.

FIG. 12 is a flow diagram illustrating an example process that supports UE-driven sequential training according to one or more aspects.

FIG. 13 is a flow diagram illustrating an example process that supports UE-driven sequential training according to one or more aspects.

FIG. 14 is a block diagram of an example UE that supports UE-driven sequential training according to one or more aspects.

FIG. 15 is a block diagram of an example base station that supports UE-driven sequential training according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FRI is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mm Wave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

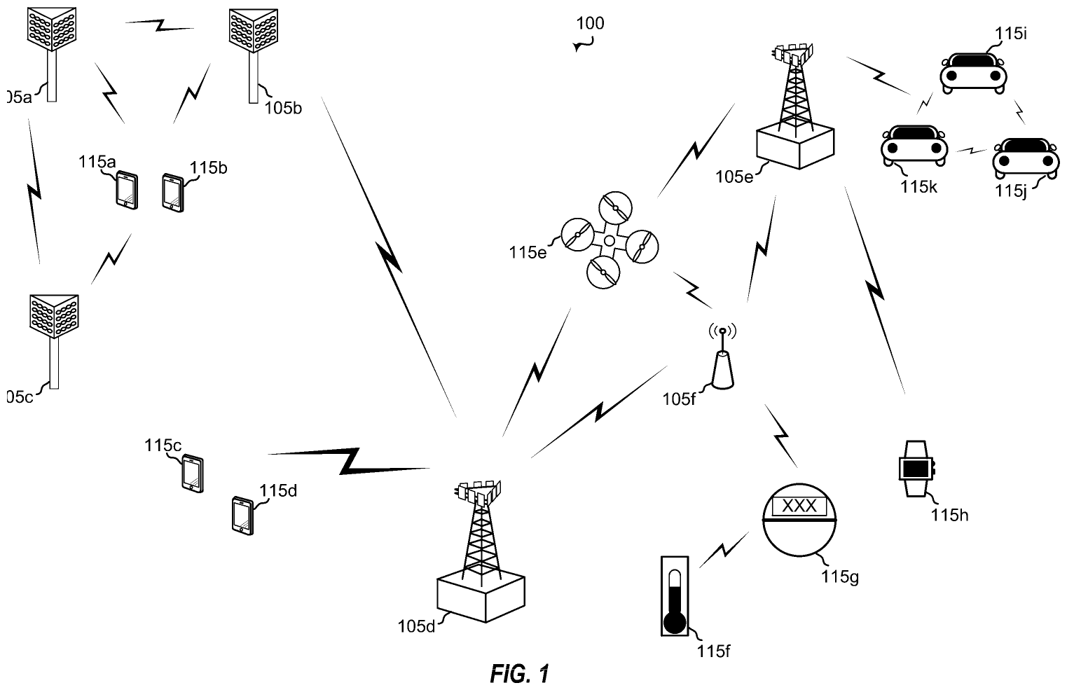

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless

In operation at wireless network 100, base stations 105a-105c serve UEs 115a and 115b using 3D beamforming and coordinated spatial techniques, such as coordinated multipoint (COMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

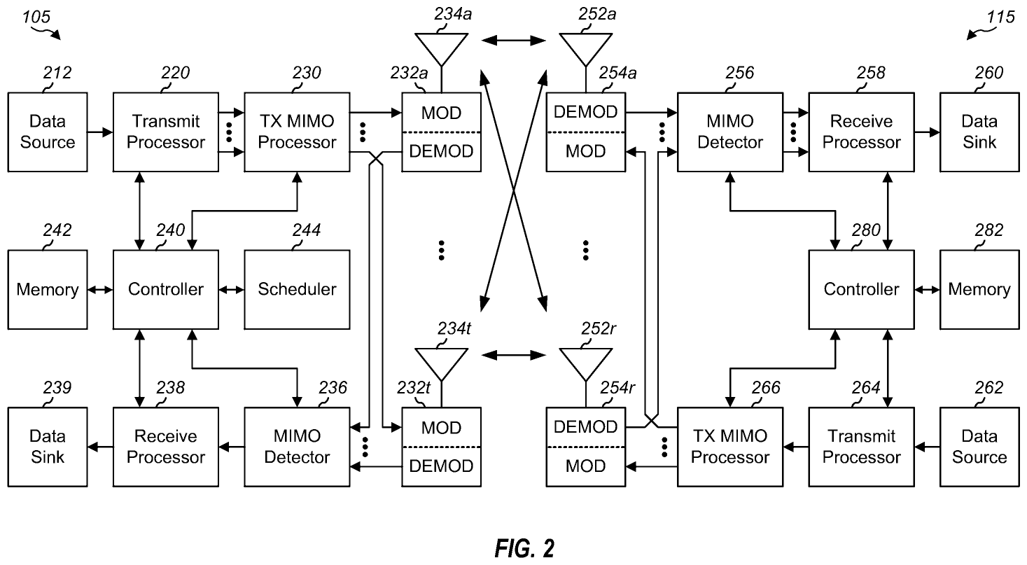

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

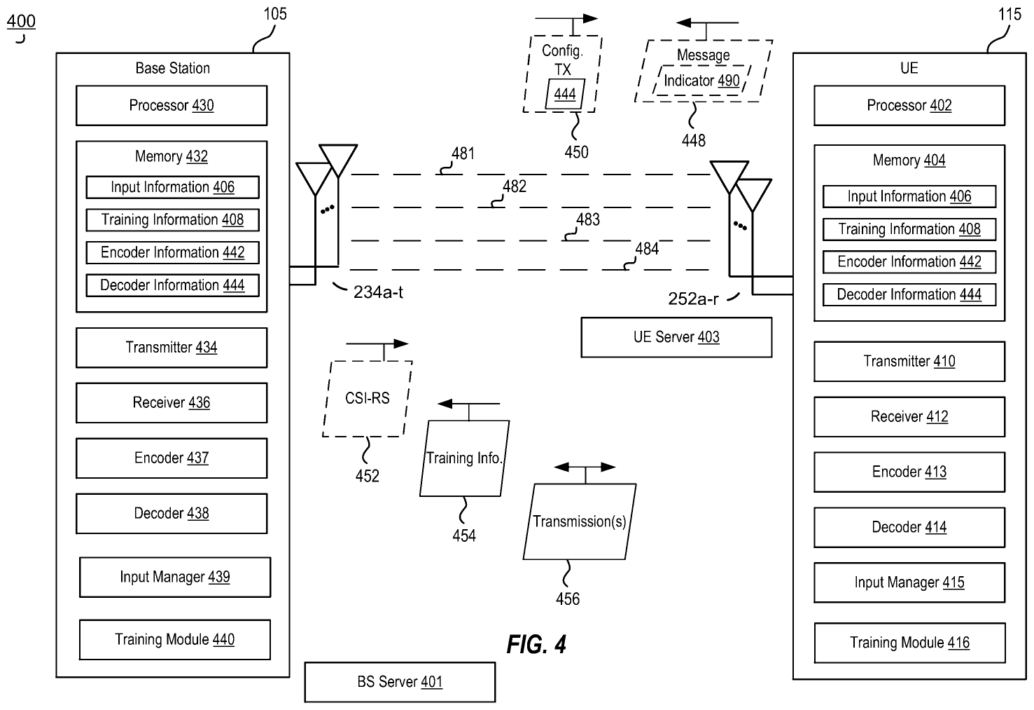

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 4-15, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

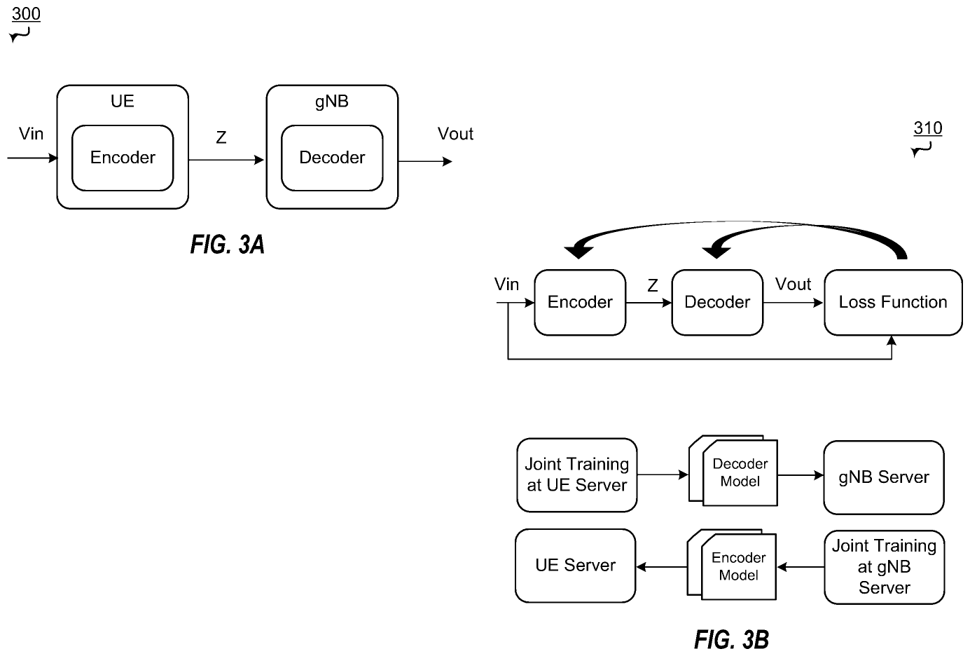

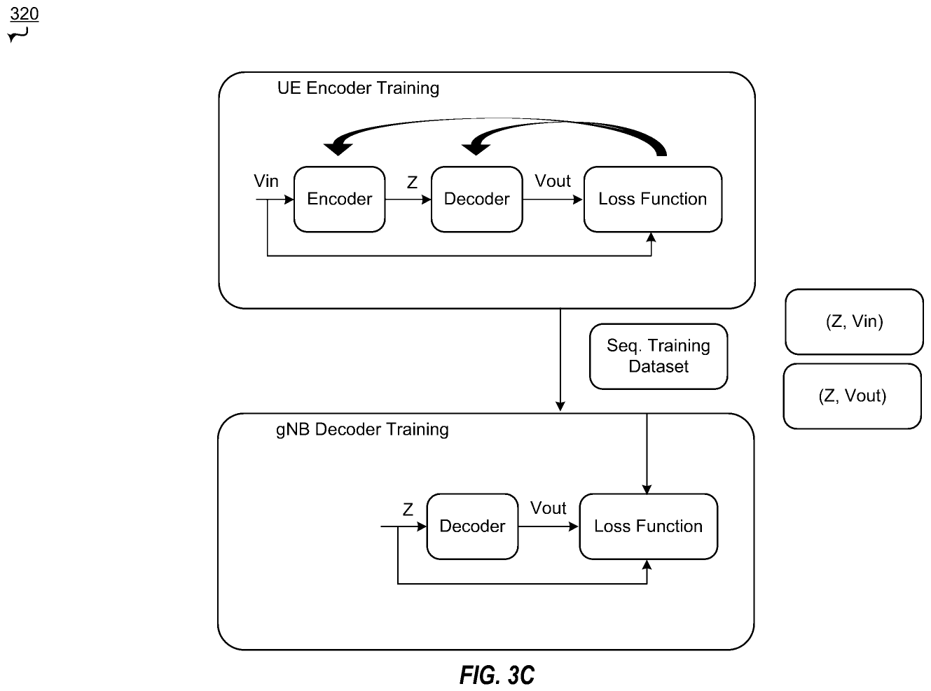

Referring to FIG. 3A, a block diagram illustrating an example of encoder decoder operations for channel state feedback according to one or more aspects is depicted. In the example of FIG. 3A, an encoder of a UE receives Vin and generates Z. The UE transmits Z to the base station (gNB), and a decoder of the base station generates Vout based on decoding Z. Vin may include or correspond to uncompressed or raw channel state feedback (CSF). Z may include or correspond to compressed CSF, and Vout may include or correspond to reconstructed or decompressed CSF (e.g., CSI and/or precoding vectors).

In some implementations, the channel state information data and/or Vin includes or corresponds to precoder vectors or channel vectors. Additionally, or alternatively, the channel state information data and/or Vin comprises raw channels.

In order to improve performance, it has been proposed to perform cross-node (X-node) machine learning (ML) training of encoders and decoders for CSF. In cross-node ML, a neural network (NN) is split into two portions, the encoder on the UE side and the decoder on the network side.

In “multi-vendor training”, each vendor (e.g. UE vendor, gNB vendor) has its own server that participates in offline training. The UE vendor servers communicate with gNB vendor servers during the training using server-to-server connections. However, doing so involves sharing the vendors'models. As the models are tied to the architecture of the encoder/decoder and the model thereof, providing a vendor specific model may lead to reverse engineering of proprietary information, such as hardware architecture (e.g., encoder/decoder architecture). As this is generally disfavored, a new scheme is needed to train multi-vendor encoders and/or decoders that can work with more devices.

Without multi-vendor training, each UE-gNB pair needs to keep different encoder-decoder pairs. For example, in a first scenario (Scenario A) multiple UE vendors with one gNB vendor, a common network decoder is trained to work with multiple UE encoders. The benefit here is that the base station does not need a separate decoder for each UE in the cell.

In a second scenario (Scenario B) for one UE vendors with multiple gNB vendors, a common encoder is trained to work with multiple gNB decoders. The benefit here is that the UE does not need a separate encoder for each gNB as it moves from cell to cell.

In a third scenario (Scenario C) multiple UE vendors with multiple gNB vendors, a common encoder-decoder pair is trained and both the UE encoder is trained to work with multiple gNB vendors and a gNB decoder is trained to work with multiple UE vendors. Such as framework enables increased compatibility and flexibility and enables a devices to have reduced requirements (e.g., less encoders/decoders) for network operation.

Referring to FIG. 3B, a block diagram illustrating an example of concurrent training according to one or more aspects is depicted. Concurrent training include joint training of the encoder and the decoder at single device, such as a UE or base station server. For example, a UE vendor (e.g. Qualcomm) may train both encoder and decoder models, using its own dataset, and shares the trained decoder model with a gNB vendor (e.g. Ericsson or Nokia). As another example, a network vendor (e.g. Ericsson or Nokia) may train both encoder and decoder models, using its own dataset, and shares the trained encoder model with a UE vendor (e.g. Qualcomm). Such training may be performed “offline” and not while connected to a network or involving interaction with a network. As mentioned above, the decoder shared with the network vendor may reveal or hint at the implementation details of the UE modem because of the symmetry that typically exists between the encoder and the decoder.

In order to overcome these challenges, enhanced sequential training techniques, such as UE-driven sequential training, can be used to protect proprietary designs while still enabling true multi-vendor encoding and decoding. In the aspects described herein, a UE side device or server may share training information with a network device or devices that enables the network to train its decoder. The training information (e.g., a sequential training dataset or UE driven sequential training dataset) may include or correspond to Z and Vin or Z and Vout. The sequential training dataset may be generated based on a standard CSI input dataset or an aggregated CSI input dataset. The CSI information of the CSI dataset may include or correspond to the same type of CSI information that would normally be used in joint/concurrent encoder and decoder training. Thus, multiple devices can be used to generate CSI or input information for generating a training data set, and multiple training data sets can be used to train a single universal decoder for use by the network with multiple UEs, or at least a particular universal decoder for a network vendor or an entire class of network devices. The universal decoder may work with/be paired with encoders of multiple different UE vendors, different UE classes or types, etc. An example of such UE-driven sequential training is shown in FIG. 3C.

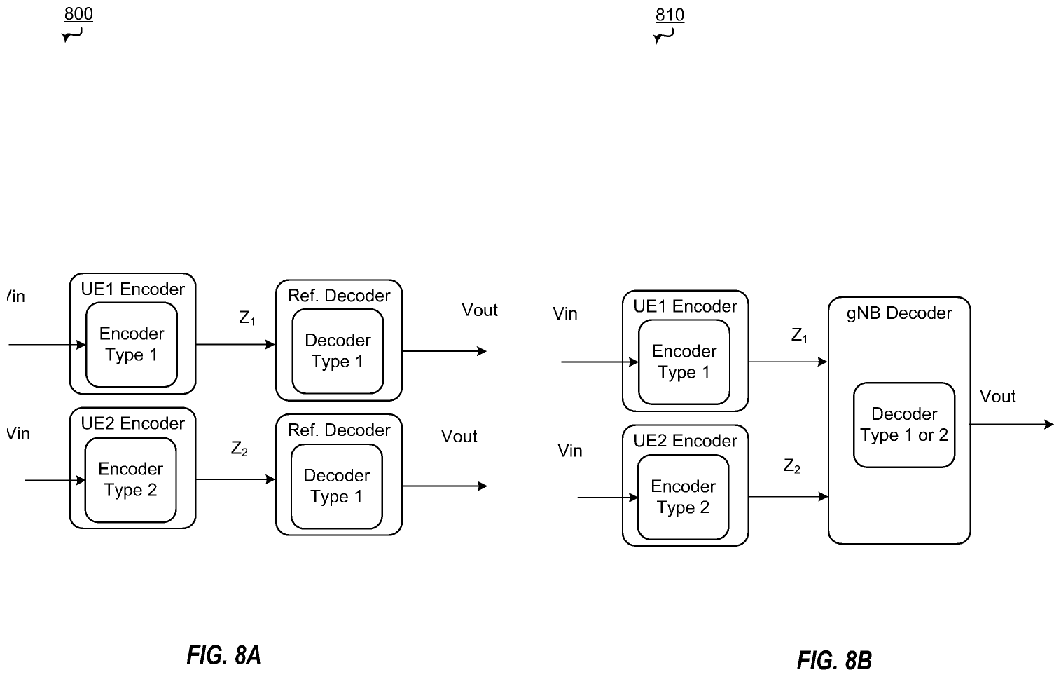

Referring to FIG. 3C, a block diagram illustrating an example of sequential training according to one or more aspects is depicted. In FIG. 3C a UE side or UE vendor device generates a training data set of Z and Vin or Z and Vout based on training its encoder and decoder concurrently, such as by concurrent joint training of a UE encoder and a decoder described with reference to FIG. 3B. The decoder may include or correspond to a reference decoder as described further with reference to FIGS. 8A and 8B. During the training an input data set is used, such as a data set of Vin.

As explained with reference to FIG. 3A, the UE encoder encodes Vin to produce Z, and the UE decoder decodes Z to produce Vout. Vin and Vout can be provided to a loss function or another comparison device or logic to determine a different or gradient. The difference or gradient between the encoder input and decoder output may represent the error. AI and/or ML methods, such as CNN or TF, may be used to adjust the model weights of the encoder and/or the decoder to better match Vin and Vout, often referred to as training.

While training the encoder and decoder, the UE device may track and store data to generate a training dataset. Alternatively, once the model is completed, the UE may feed in a standard set of inputs or the original input information to generate corresponding Zs and Vouts. The UE may then generate a training data set based on two of the three of Vin, Z, and Vout for training an encoder and/or decoder. Combinations of Z and Vin and Z and Vout may be used for training a decoder on the network side.

The UE device then provides the training information to the network side, where the network side can train its decoder to train or pair it with the UE side encoder based on the received training information. For example, as shown on the network size, Z from the training information is provided to the network decoder. The network decoder generates Vout, gnb based on the Z from the training information. The network device may provide the generated Vout, gnb and the received Vout to a loss function for comparison. The difference between to the two Vouts is the error or gradient. The network can then use this gradient to adjusted decoder model weights (the decoder model).

Alternatively, when Vin is provided, the network can provide Vin to the loss function to compare it to Vout, gnb to generate a difference or gradient. Similarly, the network can then use this gradient to adjust decoder model weights (e.g., the decoder model). When Vout is used, the network is allowed to make the same mistake (have the same error) as the UE. Using Vin may allow for correction of the original mistake or error, but may introduce new errors. A network may choose the most advantageous training set based on the outcomes, such as in real world performance.

FIG. 4 illustrates an example of a wireless communications system 400 that supports UE-driven sequential training in accordance with aspects of the present disclosure. In some examples, wireless communications system 400 may implement aspects of wireless communication system 100. For example, wireless communications system 400 may include a network, such as one or more network entities (e.g., base station 105 and base station server 401), and one or more UE side devices, such as UE 115 and UE server 403. As illustrated in the example of FIG. 4, the network entity includes a corresponds to a base station, such as base station 105. Alternatively, the network entity may include or correspond to a different network device (e.g., not a base station). UE-driven sequential training may reduce latency and increase throughput. For example, avoiding switches NN models reduces latency and increases throughput by avoiding incurring delays in switching NN models. Accordingly, network and device performance can be increased.

Base station 105, UE 115, base station server 401, and UE server 403 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mm Wave” band in documents and articles, despite being different from the extremely high frequency (EHF) band (30 GHz-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mm Wave” or the like if used herein may broadly represent frequencies that may include mid-band frequencies, may be within FR2, or may be within the EHF band.

It is noted that SCS may be equal to 15, 30, 60, or 120 kHz for some data channels. Base station 105 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management, BWP switching functionality, or both. In some implementations, two or more CCs are quasi co-located, such that the CCs have the same beam and/or same symbol.

In some implementations, control information may be communicated via base station 105, base station server 401, UE 115, and UE server 403. For example, the control information may be communicated suing MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can includes processor 402, memory 404, transmitter 410, receiver 412, encoder, 413, decoder 414, input manager 415, training module 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store input information 406, training information 408, encoder information 442, decoder information 444, settings data, or a combination thereof, as further described herein.

Input information 406 may, for example, include channel state feedback information. Channel state feedback information may, for example, include one or more measurements performed by a UE on one or more signals transmitted by a base station, such as one or more channel state information reference signals (CSI-RS) transmitted by the base station. In some embodiments, channel state feedback information may include sensed raw channel information or singular vector information for one or more beamforming vectors. Input information 406 may be categorized by a vendor of a base station with which the input information is associated or by a model of a base station with which the input information is associated. For example, input information 406 including sensing or measurement information of one or more signals from base stations identified with a first vendor may be categorized as input information associated with base stations identified with the first vendor.

Training information 408 may include one or more training data sets for a decoder of a network device. Such training information may, for example, be received from the UE server 403. The base station server 401 or base station 105 may use the training information to train (e.g., perform sequential training of) a decoder and/or adjust operation of the decoder. In some embodiments, the training information may include instructions or code received from the UE server 403 for the decoder. The training information may include or correspond to a UE driven sequential training data set. The training information may include tuples of encoder or decoder inputs and outputs, such as Z and Vin or Z and Vout.

Encoder information 442 may include one or more encoder parameters for an encoder of UE device. Such parameters may, for example, be generated by a UE or received at a UE from the UE server 403. The UE 115 may use the encoder parameter information to adjust operation of the encoder for encoding information to be transmitted to a base station, such as for encoding channels state feedback information for transmission to a base station. In some embodiments, the encoder parameter information may include instructions or code received from the UE server 403 for the encoder.

Decoder information 444 may include one or more decoder parameters for a decoder of a network device. Such parameters may, for example, be generated by a base station or received at a base station from the base station server 401. The base station 105 may use the decoder parameter information to adjust operation of the decoder for decoder information received at a base station, such as for decoding channels/channel state feedback information from a UE. In some embodiments, the decoder parameter information may include instructions or code received from the base station server 401 for the decoder of the base station 105.

The settings data includes or corresponds to data associated with UE-driven sequential training operations. The settings data may include one or more types of UE-driven sequential training operation modes and/or thresholds or conditions for switching between UE-driven sequential training modes and/or configurations thereof. For example, the settings data may have data indicating different thresholds and/or conditions for different UE-driven sequential training modes, such as a network assisted mode, an increased complexity mode, a same complexity mode, etc., or a combination thereof.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both may include or correspond to one or more components of UE 115 described with reference to FIG. 2.

Encoder 413 and decoder 414 may be configured to encode and decode data for transmission. The input information generation manager may generate input information, such as by sensing or measuring one or more signals from one or more base stations or processing the sensed or measured information.

The training module may be configured to train an encoder, decoder, or both. For example, the encoder 413 and a reference decoder may be trained by a training module of the UE. For example, a concurrent training module may employ one or more ML algorithms to train the encoder and the decoder jointly using the input information 406. For example, if the input information 406 includes CSI information, the training module may adjust parameters of the encoder and the decoder such that the encoder produces similar output information to the output information of the decoder when the input information is input to the encoder 413. The training information 408 may be generated during or after training of the encoder and decoder by the UE 115.

UE server 403 may include one or more elements similar to UE 115. In some implementations, the UE 115 and the UE server 403 are different types of UEs. For example, either UE may be a higher quality or have different operating constraints. To illustrate, one of the UEs may have a larger form factor or be a current generation device, and thus have more advanced capabilities and/or reduced battery constraints, higher processing constraints, etc.

Base station 105 includes processor 430, memory 432, transmitter 434, receiver 436, encoder 437, decoder 438, input manager 439, training module 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store input information 406, training information 408, encoder information 442, decoder information 444, settings data, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both may include or correspond to one or more components of UE 115 described with reference to FIG. 2.

Encoder 437, and decoder 438 may include the same functionality as described with reference to encoder 413 and decoder 414, respectively. Input manager 439 may include similar functionality as described with reference to input manager 415. Training module 440 may include similar functionality as described with reference to training module 416. For example, training module may be configured to train (sequentially train) the decoder 438 of the base station 105. To illustrate, the training module may employ one or more ML algorithms to train the decoder 438 using the training information 408. The training module may adjust parameters of the decoder 438 to enhance operation of the decoder in successively decoding training information 408. To illustrate, the decoder 438 may be fed Z from the training information 408 and output a base station decoded output, which is compared to the UE side encoder input or decoder output of the training information 408. A difference from the comparison can be used to adjust the decoder (e.g., the weights thereof) and to generate decoder information 444.

Base station server 401 may include one or more elements similar to base station 105. In some implementations, the base station 105 and the base station server 401 are different types of base stations. For example, either base station device may be a higher quality or have different operating constraints. To illustrate, one of the base station devices may have a larger form factor or be a current generation device, and thus have more advanced capabilities and/or reduced power constraints, higher processing constraints, etc.

During operation of wireless communications system 400, the network (e.g., base station 105) may determine that UE 115 has UE-driven sequential training capability. For example, UE 115 may transmit a message 448 that includes an UE-driven sequential training indicator 490 (e.g., an UE-driven sequential training capability indicator). Indicator 490 may indicate UE-driven sequential training capability for one or more communication modes, such as downlink, uplink, etc. In some implementations, a network entity (e.g., a base station 105) sends control information to indicate to UE 115 that UE-driven sequential training operation and/or a particular type of UE-driven sequential training operation is to be used. For example, in some implementations, configuration transmission 450 is transmitted to the UE 115. The configuration transmission 450 may include or indicate to use UE-driven sequential training operations or to adjust or implement a setting of a particular type of UE-driven sequential training operation. For example, the configuration transmission 450 may include decoder information 444, as indicated in the example of FIG. 4, input information 406, training information 408, encoder information 442, settings data or any combination thereof.

During operation, devices of wireless communications system 400, perform UE-driven sequential training operations. For example, the network and UE 115 may exchange transmissions via uplink and/or downlink communications and generate channel state information or feedback.

In the example of FIG. 4, the base station 105 optionally transmits a CSI-RS 452 to the UE 115 via a downlink channel. The CSI-RS includes reference signals for the UE 115 to measure and generate or estimate channel conditions, channel state information. The estimated channel conditions may include uplink conditions, downlink conditions, sidelink conditions, etc. The UE 115 may report or feedback the CSI as CSF to the base station 105.

For example, the UE 115 receives the CSI-RS 452, and the UE 115 measures the CSI-RS 452 to generate CSI. The UE 115 may generate the input information 406 based on the CSI. Additionally, or alternatively, the UE 115 may generate the input information 406 based on historical CSI information, such as from previous communications or from the communications of other devices. The UE 115 may engage in concurrent training of its encoder and decoder by the training module 416, such as described with reference to FIG. 3C. During the training of the encoder and decoder, the UE 115 may generate encoder information 442 and/or decoder information 444, such as encoder and decoder model weights.

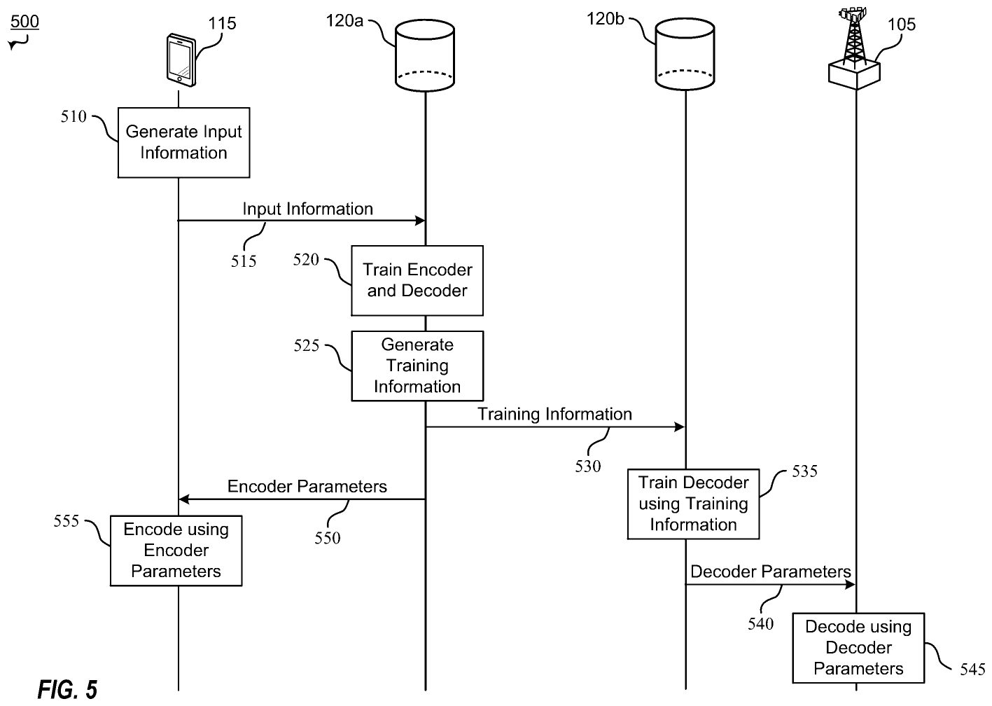

The UE 115 may further generate the training information 408 based on training the encoder and the decoder or after training the encoder and decoder. Additionally, the UE 115 may generate the training information 454 (e.g., aggregate training information) based on the training information 408 and second received training information, such as described with reference to FIGS. 5-7.

The UE 115 transmits the training information 454 to the base station 105. For example, the UE 115 may transmit training information 454 in an uplink message/uplink channel. Alternatively, the UE 115 may transmit training information 454 to the base station server 401 or the UE server 403. When providing the training information 454 to the UE server 403, the UE server 403 may aggregate the training information 454 and relay the aggregated training information to the base station 105 or the base station server 401.

In other implementations, the UE 115 transmits the input information 406 (e.g., CSI information) to the UE server 403 and the UE server 403 generates the training information 454. The UE server 403 may aggregate additional input information and generate the training information 454 as described with reference to FIGS. 5-7.

The base station 105 receives the training information 454 and trains its decoder 438 based on the training information 454. For example, the base station 105 may train its decoder 438 as described with reference to FIG. 3C. During or after training of the decoder 438, the base station 105 generates the decoder information 444 (e.g., decoder model weights).

Alternatively, the training information may be provided to the base station server 401, and the base station server 401 may train an encoder based on the training information 454 to generate the decoder information 444. The base station server may provide the decoder information 444 to the base station to use, as described with reference to FIGS. 5-7.

After the shared or universal encoder of the UE 115 is trained and the shared or universal decoder of the base station 105 is trained, the UE 115 and base station 105 may communicate one or more transmissions 456 using the respective encoder and decoder. For example, the UE 115 transmits a transmission of the one or more transmission 456 by encoding data (e.g., second CSI data) based on the encoder information 442 (encoder model trained based on the encoder information 442). The base station 105 receives the transmission of the one or more transmission 456 by decoding the encoded data (e.g., the second CSI data) based on the decoder information 444 (decoder model trained based on the decoder information 444).

Accordingly, the network (e.g., the base station 105, the base station server 401, the UE 115, and the UE server 403) may be able to more efficiently and effectively train multiple vendor encoders and decoders. Improved encoding and decoding operations, such as improved compression and reconstruction of CSI information, may be achieved, resulting in lower overhead and errors. Accordingly, the network performance and experience may be increased due to the increases in throughput and reductions in failure.

FIG. 5 is a timing diagram for a system 500 that supports UE driven sequential training. The system 500 may include a UE 115, a UE-side server 120a, a base station-side server 120b, and a base station 105. The UE 115 and the UE-side server 120a may be associated with a same UE vendor, such as a same manufacturer or designer, a same UE class, such as advanced, RedCap, or both. For example, the UE-side server 120a may generate training data to enable a particular vendor to train one or more decoders for implementation by base stations associated with the particular vendor. To illustrate, a base station-side server 120b may train one or more decoders based on received training information from the UE-side server 120a and for implementation by network devices which are associated with the particular vendor and may be operated by the same vendor.

As another example, the UE-side server 120a may train one or more encoders for implementation by UEs associated with a particular vendor and may be operated by the same vendor. To illustrate, the UE-side server 120a may train a shared or universal UE encoder based on multiple sets of input information and may share or distribute encoder model information to multiple UEs to train the UEs.

The UE-side server 120a may control training of one or more encoders by the UE-side server 120a by generating training information for use by the UE-side server 120a in training one or more encoders. Such control may enable interoperability and enhanced encoding and decoding efficiency and reliability between encoders implemented by UEs and decoders implemented by base stations without requiring a vendor operating the UE-side server 120a to reveal details of decoders or encoders trained by the UE-side server 120a and implemented on one or more base stations, such as without revealing decoder output information or encoder parameters. In some embodiments, the system 500 may include multiple UE-side servers associated with multiple respective UE vendors or multiple base station-side servers associated with multiple base station-side servers. For example, a single UE-side server 120a in a single training session may train an encoder using input information received from multiple UE-side servers associated with different respective UE vendors and may generate and transmit a same set of training information to the multiple UE-side servers associated with the different respective UE vendors.

At 510, the UE 115 may generate input information. The input information may, for example, include channel state feedback information. Generating input information at 402 may include performing one or more measurements of one or more signals, such as CSI-RS, transmitted by one or more base stations, such as base station 105. Such base stations may, for example, include base stations associated with the same vendor as the base station-side server 120b. In some embodiments, the UE 115 may generate input information using signals received from multiple base stations associated with multiple vendors.

At 515, the UE 115 may transmit the input information to the UE-side server 120a. The UE-side server 120a may, for example, be a UE-side server operated by a same vendor as a vendor associated with the UE 115. The transmitted input information may, for example, include the input information generated based on signals from multiple base stations associated with multiple different respective vendors, multiple base stations associated with a single vendor, or a single base station associated with a single vendor. In some embodiments, the input information received from base stations associated with different vendors may be identified for separate processing by the UE-side server 120a. The UE-side server 120a may receive the input information from multiple UEs associated with the same vendor as the UE-side server. Thus, in some embodiments, the UE-side server may store multiple sets of input information associated with multiple respective base station vendors. Additionally, or alternatively, the UE-side server 120a may aggregate sets of input information from multiple UEs and for a particular base station vendor.

At 520, the UE-side server 120a may train an encoder and a decoder. For example, the UE-side server 120a may train an encoder to generate training information for transmission to one or more base stations. The encoder may include or correspond to a UE side encoder, such as a shared or universal encoder. Additionally, the UE-side server 120a may determine one or more encoder parameters for transmission to one or more UEs. In some implementations, when training the encoder the UE-side server 120a may also train a corresponding decoder (e.g., reference decoder) to generate the training information, such as performing one-sided concurrent training, which may be done offline. The UE-side server 120a may train the encoder and decoder using the input information received at 515. In some embodiments, the UE-side server 120a may train the encoder and decoder using one or more ML algorithms. In some embodiments, the UE-side server 120a may train the encoder and decoder using input information received from one or more UEs, input information received from one or more other UE-side servers, or other input information generated by the UE-side server 120a.

As indicated above, the UE-side server 120a may train multiple encoders, such as one encoder for each vendor, one encoder for each class, one encoder for each combination of vendor and class, etc. The UE-side server 120a may then transmit the corresponding training data for each class to the respective base stations or base station-side servers.

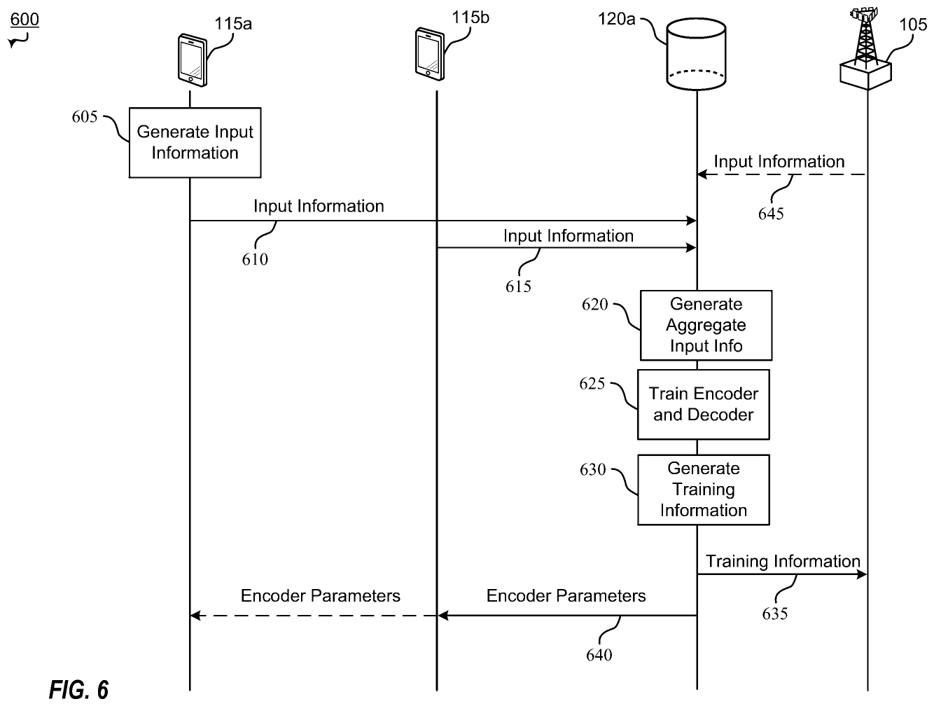

In some implementations, when the encoder is trained by the UE-side server 120a, a base station-side device (e.g., gNB or server) may provide input information to the encoder, such as reference decoder information or model weights, as described further with reference to FIG. 6. The trained encoder may encode and output encoded information, such as encoded input information for a decoder.

At 525, the UE-side server 120a may generate training information. For example, the UE-side server 120a may use the trained encoder and decoder to generate the training information. The training information may be generated during the training, or after completion of the training. In some implementations, the input information may be provided (reprovided) after training is completed to generate a sequential training dataset for training network side decoders. The UE-side server 120a may generate a training dataset based on Z and Vin or Z and Vout.

In some embodiments, the UE-side server 120a may train encoders and decoders at 520 and generate training information at 525 for each of multiple UE-side servers associated with different UE vendors. For example, the UE-side server 120a may train encoders that are specific to particular UE vendors with one or more actual network decoders or reference decoders. In some embodiments, the UE-side server 120a may train a single encoder and decoder, and generate single training information for multiple UE vendors using input information from the multiple UE vendors in a single training session. In some embodiments, the UE-side server 120a may train multiple encoders. The UE-side server 120a may generate multiple sets of training information, such as multiple sets of training information for multiple base station-side servers. For example, sets of training information for specific UE-side servers may be generated by passing input information received from each respective UE or UE-side server through encoders and decoders trained with input information from each respective UE vendor and/or class or by passing sets of input information received from each respective UE-side device through a single encoder and decoder pair to generate the sets of training information.

At 530, the UE-side server 120a may transmit the training information generated by the trained encoder and decoder to the base station-side server 120b. For example, the UE-side server 120a may transmit the training information by a wired or wireless connection. For example, the training information may include or correspond to a training dataset including Z and Vin or including Z and Vout. These components may be arranged as tuples, corresponding pairs of information or multiple items stored as a single variable or input for training a decoder.

At 535, the base station-side server 120b may train a decoder using the training information received from the tore multiple items in a single variable. In some embodiments, the base station-side server 120b may train multiple decoders using multiple sets of training information received from multiple respective UE-side servers or devices and associated with different vendors, different class devices, or both. Training the decoder (or decoders) may include applying one or more ML algorithms to generate decoder parameters. Decoder parameters may, for example, include computer code, instructions, weights, vectors, or other decoder parameters for use by the base station 105. In some embodiments, to train the decoder, the base station-side server 120b may pass input information (e.g., Z) of tuples of the training information through the decoder and may adjust parameters (e.g., model weights) of the decoder until the output of the decoder (Vout, gnb) is close to or matches the output (e.g., Vin or Vout) of the respective tuple. When the decoder is trained, the base station-side server 120b may, at 540, transmit decoder parameters to the base station 105.

At 545, the base station 105 may decode information using the received decoder parameters. Thus, the base station-side server 120b may provide training information for training a decoder to be used by one or more base stations. Such training may be remote, as a remote base station-side server and a UE-side server may cooperate to train a decoder for use by one or more base stations, the training may be offline, as the UE-side server and the base station-side server may train encoders and decoders while the encoders and decoders are not being used to encode or decode information for transmission, and the training may be sequential, as the UE-side server may train an encoder to generate training information for use by the base station-side server in training a decoder.

At 550, the UE-side server 120a may transmit the encoder parameters to the UE-side server 120a. Although the transmission of encoder parameters (encoder parameter information or encoder model information), is illustrated as being transmitted after the model information and before the transmission of decoder parameters, the transmission of encoder parameter may happen at any time after generation or adjustment of the encoder parameters, such as any time after 520 or 525.

At 555, the UE 115 may encode information using the received encoder parameters. Thus, the UE-side server 120a may provide encoder parameters for training an encoder to be used by one or more UEs. Such training may be remote, as a remote UE-side server and a remote base station-side server may cooperate to train an encoder for use by one or more UEs, the training may be offline, as the UE-side server and the base station-side server may train an encoder while the encoder is not being used to encode information for transmission, and the training may be sequential, as the base station-side server may train an encoder to generate training information for use by the UE-side server in training an encoder.

Alternatively, the UEs may train their own encoders based on the input and similar to how the UE servers transmit the information. Although described as UE servers, the UE servers may include or correspond to an advanced UE or master UE.

FIG. 6 is a timing diagram for a system 600 that supports UE driven sequential training. The system 600 may include one or more UEs (e.g., UE 115), a UE-side server 120a, and one or more network devices, such as a base station-side server 120b or a base station 105. In the example, illustrated in FIG. 6, two UEs are illustrated, a first UE 115a and a second UE 115b, with a single a UE-side server 120a and a single base station 105 The UEs 115a and 115b and the UE-side server 120a may be associated with a same UE vendor, such as a same manufacturer or designer, a same UE class, such as advanced, RedCap, or both. For example, the UE-side server 120a may aggregate input information from multiple UEs, generate aggregate training information, and provide the aggregate training information for the training of network side decoders by a network, such as a particular network vendor. As another example, the UE-side server 120a may train one or more encoders for implementation by UEs associated with a particular vendor and may be operated by the same vendor.

At 605, the first UE 115a may generate first input information. The first input information may, for example, include first channel state feedback information. Generating the first input information at 605 may include performing one or more measurements of one or more signals, such as CSI-RS, transmitted by one or more base stations, such as base station 105. In some embodiments, the first UE 115a may generate the first input information using signals received from multiple base stations associated with multiple vendors. Additionally, or alternatively, the first UE 115a may generate the first input information using signals from communications with the UE-side server 120a. In other implementations, the first UE 115a retrieves historical input information.

At 610, the first UE 115a may transmit the first input information to the UE-side server 120a. The UE-side server 120a may, for example, be a UE-side server operated by a same vendor as a vendor associated with the first UE 115a. In some embodiments, the first input information received from base stations associated with different vendors may be identified for separate processing by the UE-side server 120a. The UE-side server 120a may receive different sets of input information from multiple UEs associated with the same vendor as the UE-side server. Thus, in some embodiments, the UE-side server 120a may store multiple sets of input information associated with multiple respective base station vendors. Additionally, or alternatively, the UE-side server 120a may aggregate sets of input information from multiple UEs and for a particular base station vendor.

At 615, the second UE 115b may transmit second input information to the UE-side server 120a. The UE-side server 120a may, for example, be a UE-side server operated by a same vendor as a vendor associated with the second UE 115b. The transmitted second input information may, for example, include second input information generated by the second UE 115b and based on signals from multiple base stations associated with multiple different respective vendors, multiple base stations associated with a single vendor, or a single base station associated with a single vendor.

In some implementations, the first UE 115a and the second UE 115b are the same type of UE, such as both advanced UEs, both Red Cap UEs, etc. In other implementations, the first UE 115a and the second UE 115b are different types of UEs. When the UEs are different type, the UE-side server 120a may not aggregate their input data or may aggregate their input data in different ways. Similarly, when the UEs are from different vendors and/or generate their respective input information from different types of base station or base stations operated by different vendors, the UE-side server 120a may not aggregate their input data or may aggregate their input data in different ways. Although not shown in FIG. 6, the second UE 115b may generate the second input information.

At 620, the UE-side server 120a may generate (e.g., aggregate) aggregate input information. For example, the UE-side server 120 may combine the first input information and the second input information to generate the aggregate input information. As another example, the UE-side server 120 may modify the first input information based on the second input information to generate the aggregate input information or may modify the second input information based on the first input information to generate the aggregate input information. In some implementations, the UE-side server 120 may generate (e.g., aggregate) aggregate input information based on the first input information and the second input information based on determining that the first UE 115a and the second UE 115b are similar devices, such as have a same encoder architecture, have a similar encoding complexity, are a similar or same type of device, etc.

At 625, the UE-side server 120 may train an encoder and a decoder. For example, the UE-side server 120a may train an encoder to generate (aggregate) training information for transmission to one or more base stations. The encoder may include or correspond to a UE side encoder, such as a shared or universal encoder. Additionally, the UE-side server 120a may determine one or more encoder parameters for transmission to one or more UEs. In some implementations, when training the encoder the UE-side server 120a may also train a corresponding decoder (e.g., reference decoder) to generate the training information, such as performing one-sided concurrent training, which may be done offline. The UE-side server 120a may train the encoder and decoder using the aggregate input information generated at 620. In some embodiments, the UE-side server 120a may train the encoder and decoder using one or more ML algorithms. In some embodiments, the UE-side server 120a may train the encoder and decoder using aggregated input information received from one or more UEs, input information received from one or more other UE-side servers, or other input information generated by the UE-side server 120a.

As described with reference to FIG. 5, the UE-side server 120a may train multiple encoders and decoders, such as encoder-decoder pairs for different classes of UEs and/or for different vendors. Additionally, as described with reference to 645, in some implementations the UE-side server 120a may train a particular encoder-decoder pair based on network side information, such as decoder information.

At 630, the UE-side server 120a generates training information, such as described with reference to 525 of FIG. 5. As the training information may be based on aggregated input information, the training information may be referred to as aggregate or aggregated training information. The aggregated training information may be used to train a network side decoder which is paired with and capable of operating with more UEs (i.e., the encoder thereof).

At 635, the UE-side server 120a may transmit the training information to the base station 105. Additionally, or alternatively, the UE-side server 120a may transmit the training information to a base station-side server and/or one or more other base stations. The transmission of the training information may be wired or wireless.

After receiving the training information, the base station 105 may train a decoder as described with reference to 535 of FIG. 5. Additionally, or alternatively, the base station 105 may transmit the training information, the decoder information, or both to one or more other network devices, such as base stations and/or base station-side servers.

At 640, the UE-side server 120a may transmit the encoder parameters to one or more UE side devices, such as one or more UEs and/or one or more other UE-side servers. As illustrated in the example of FIG. 6, the UE-side server 120a transmits the encoder parameters to the second UE 115b and optionally, to the first UE 115a. In some implementations, a UE, such as the second UE 115b, may transmit the encoder parameter to one or more other UE side devices, such as one or more UEs and/or one or more other UE-side servers.

Although the transmission of encoder parameters (encoder parameter information or encoder model information), is illustrated as being transmitted after the training information, the transmission of encoder parameter may happen any time after training of the encoder and generation or adjustment of the encoder parameters, such as any time after 625 or 630.

After receiving the encoder parameters, the UE 115 may encode information using the received encoder parameters as described with reference to 555 of FIG. 5. Thus, the UE-side server 120a may provide encoder parameters for training an encoder to be used by one or more UEs. Such training may be remote, as a remote UE-side server and a remote base station-side server may cooperate to train an encoder for use by one or more UEs, the training may be offline, as the UE-side server and the base station-side server may train an encoder while the encoder is not being used to encode information for transmission, and the training may be sequential, as the base station-side server may train an encoder to generate training information for use by the UE-side server in training an encoder.

Additionally, after receiving the training information based on aggregate input information from multiple UE side devices, a base station side device can train one or more network decoders based on the training information. The base station device or devices may then decode encoded information using the decoders (trained on the training information) as described with reference to 545 of FIG. 5. Thus, the UE-side server 120a may provide training information for training a decoder to be used by one or more network devices that can be used with multiple UE devices and UE vendors.

In some implementations, base station 105 (or a base station-side server) may generate input information for the UE-side server 120a (or a UE) to use in training the encoder and the decoder. For example, the base station 105 may generate information about the actual decoder it uses or will use in communication with UEs or a reference decoder to use in training UE side encoder. Reference decoders may be different from (e.g., more complex than) the actual decoder and are described further with reference to FIGS. 8A and 8B. As an illustration, the base station 105 may generate decoder information, reference decoder information, initial weight information, final weight information, or a combination. At 645, the base station 105 may transmit the generated input information to the UE-side server 120a for use in training the encoder and the decoder at 625. Thus, the base station-side devices may enable or help the UE side train its encoder and generate the training information for use in training the decoder. This additional information may enable increased accuracy and reduced bottlenecks.

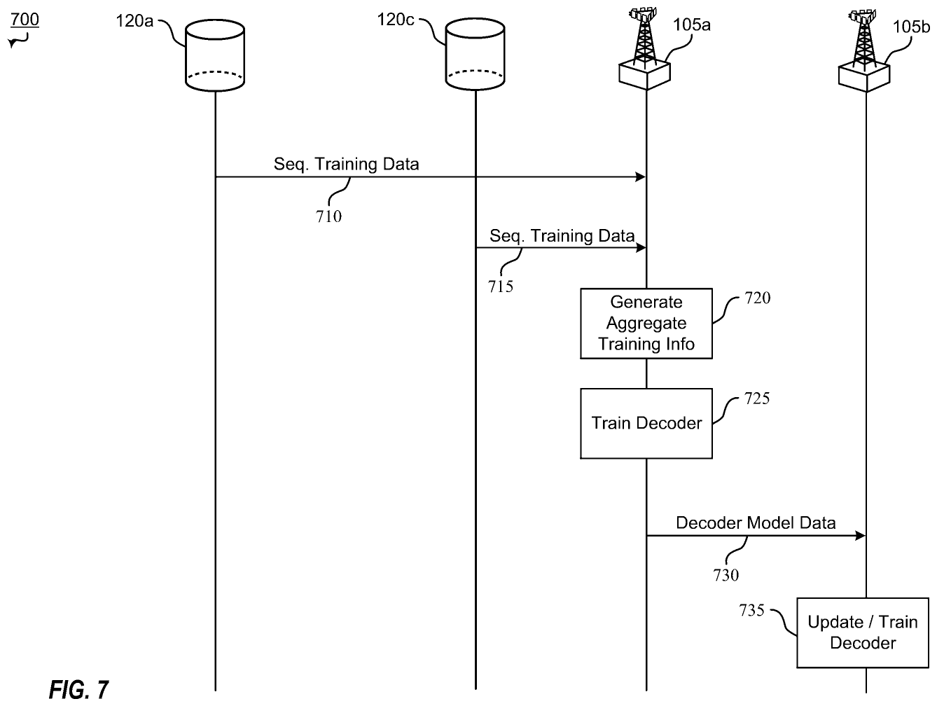

FIG. 7 is a timing diagram for a system 700 that supports UE driven sequential training. The system 700 may include one or more UE side devices (e.g., a UE 115 or a UE-side server) and one or more network devices, such as a base station-side server 120b or a base station 105. In the example, illustrated in FIG. 7, two UE-side servers are illustrated, a first UE-side server 120a and a second UE-side server 120c and two base stations are illustrated, a first base station 105 and a second base station 105. The UE-side servers 120a and 120c may be associated with a different UE vendor, such as a different manufacturer or designer, a different UE class, or both. For example, the first UE-side server 120a may aggregate first input information from multiple first UEs of a certain vendor and/or type, and the second UE-side server 120c may aggregate second input information from multiple second UEs of a different vendor and/or type. Each UE-side server may generate respective aggregate training information based on its own aggregate input information, and may provide the respective aggregate training information for the training of network side decoders by a network, such as a particular network vendor or type. As example with respect to previous figures, the UE-side servers may optionally train one or more encoders for implementation by UEs associated with the UE-side servers.

At 710, the first UE-side server 120a may transmit first training information to the first base station 105a; at 715, the second UE-side server 120c may transmit second training information to the first base station 105a. Although not shown in FIG. 7, the first UE-side server 120a and the second UE-side server 120c may generate their respective training information as described above with reference to 525 of FIGS. 5 and 630 of FIG. 6.

At 720, the first base station 105a may generate (e.g., aggregate) aggregate training information. For example, the first base station 105a may combine the first training information and the second training information to generate the aggregate training information. As another example, the first base station 105a may modify the first training information based on the second training information to generate the aggregate training information or may modify the second training information based on the first training information to generate the aggregate training information. In some implementations, the first base station 105a may generate (e.g., aggregate) aggregate training information based on the first training information and the second training information based on determining that the first UE-side server 120a and the second UE-side server 120c correspond to or associated with similar devices, such as their training data was generated based on input information from devices which have a same encoder architecture, have a similar encoding complexity, are a similar or same type of device, etc. In some implementations, the first base station 105a may aggregate the training information even if the first UE-side server 120a and the second UE-side server 120c are from different vendors or their training information relates to different vendors/UEs.

In other implementations, the aggregate data may be further based on network data. For example, one or more network devices (e.g., second base station 105b) may provide training information, such as received UE driven or UE side training information, to the first base station 105a. As another example, one or more network devices may provide input information data, such as decoder information, reference decoder information, or decoder weight information, to one or more of the UE side devices for use in generating the underlying training information provided to the first base station 105a. An example of such input information is described with reference to FIG. 6.

At 725, the first base station 105a may train a decoder using the training information. In some embodiments, the first base station 105a may train multiple decoders using multiple sets of training information received from multiple respective UE-side servers associated with different vendors, different class devices, or both. Training the decoder may include applying one or more ML algorithms to generate decoder parameters. Decoder parameters may, for example, include computer code, instructions, weights, vectors, or other decoder parameters for use by the first base station 105a, the second base station 105b, and/or one or more other base stations. In some embodiments, to train the decoder, the first base station 105a may pass input information of tuples of the training information through the decoder and may adjust parameters of the decoder until the output of the decoder is close to or matches the output of the respective tuple. When the decoder is trained, the first base station 105a may, at 730, transmit decoder parameters to the second base station 105b.

Although the first base station 105a trains its own decoder and generates decoder model data for transmitting/sharing with other network side devices in the example of FIG. 7, in other implementations, the first base station 105a may share the aggregated training data with one or more other network devices, such as the second base station 105b and/or one or more base station-side servers.

At 735, the second base station 105b may train or update a decoder using the received decoder parameters. The second base station 105b may train the decoder as described at 535 and with reference to FIG. 5. The second base station 105b may update a trained decoder based on retraining the trained decoder based on the decoder parameters or by generating or training a second decoder to be used with additional device classes.

After 735, the base station 105 may decode information using the received decoder parameters. For example, the base station 105 may decode encoded information received from one or more different UEs using the decoder trained based on the received decoder parameters. Thus, the UE-side servers may provide training information for training a decoder to be used by one or more base stations.

Additionally, or alternatively, one or more operations of FIGS. 4-7 may be added, removed, substituted in other implementations. For example, in some implementations, the example steps of FIGS. 6 and 7 may be used together and/or with the steps of FIG. 4 or 5. To illustrate, the generation of aggregate input information of FIG. 6 may be used with the examples of FIGS. 4, 5, and 7. As another illustration, the generation of aggregate training information of FIG. 7 may be used with the examples of FIGS. 4-6.

Although specific types of devices (BS or BS server and UE or UE server) are described in the examples of FIGS. 4-7, in other implementations other types and combinations of devices may be used. Specifically, additional devices of all types may be used to further increase the applicability and universality of the encoders and decoder. As anther example, UE side devices (UE and UE server) and base station side devices (BS and BS server) may be interchangeable with each other. To illustrate, one or more of the UE side servers in the example of FIG. 7 may be UEs in other examples. As another illustration, one or more of the base stations in the example of FIG. 7 may be base station servers.

Complexity of the encoder and of the decoder impact the overall encoding and decoding capabilities of the network. For example, the amount or degree of compression and the degree of lossless reconstruction depend on the complexity and accuracy of the encoder and decoder. This includes the ML models used to train the encoder and decoders. To illustrate, certain ML models have higher complexity than others (e.g., TF is higher than CNN). Additionally, generally adding layers to the NN adds complexity. Thus, encoders and decoders can be assigned a complexity (e.g., complexity score) based on a type (ML architecture) and a quantity of layers. Additionally, the encoders and/or decoders can be assigned a complexity based on one or more other factors and/or without the type or quantity of layers.

In operation, there may be different scenarios for the complexity of the encoder and decoders used in a network. For example, a network decoder may have the same complexity as a best UE encoder. In such implementations, operation of the network may result in performance degradation as compared to the same encoder-decoder pair in 1-to-1 concurrent training. This is because the sequential training may impart additional variance which could lead to additional errors in encoding/compression and decoding/decompression, without increasing complexity.

As another example, the network decoder may be more complex than a best UE encoder. In such implementations, operation of the network may be improved as compared to the above example. To illustrate, in such examples the decoder will no longer be the limiting factor, and it may be able to compensate for sequential training and training with a training dataset as opposed to concurrently with actual inputs and outputs.

However, as indicated above, vendors are not likely to share specific implementation details of their respective encoders and decoders. In the aspects described herein, it is proposed to share basic encoder and/or decoder information to help the training process. For example, basic complexity scores or class indications could be used to avoid unnecessary bottlenecks. As another example, ML architecture and layer information could be used for better encoder-decoder pairing. In addition, initial weights could be provided to help the training process without providing a full encoder or decoder model.

As mentioned above, a UE side device, such as a UE or server, may jointly train a UE encoder and a decoder to generate the training data for the network. This decoder may be referred to as a training decoder or a reference decoder as it is a pseudo stand in decoder for the network decoder to be used in actual operations. In different implementations, a UE side device may have different levels of knowledge of the decoder used by the network. This knowledge may span from a total lack of knowledge to nearly complete knowledge. In some implementations, we can assign a level to an amount of knowledge a UE has on the decoder used by the network.

For example, a first level (e.g. level 0) of knowledge may correspond to no knowledge of the decoder of the network. In some such an implementations, the UE may not know an architecture of the neural network of the decoder, the quantity of layers, a complexity level, etc. In such implementations, the UE may select a reference decoder based on an architecture or type of its own encoder to provide a better match or symmetry. Alternatively, the UE may select a more complex reference decoder. For example, the UE may determine to increase a complexity score from its own complexity score, such as by going up a layer in NN complexity (e.g., CNN to transformer NN) or layer complexity (e.g., add a layer).

As another example, a second level (e.g. level 1) of knowledge may include basic knowledge of the decoder of the network. In such implementations, the UE selects the decoder based on such knowledge. The information on the network decoder may be obtained from a network device or a public database. As an illustrative, example, the decoder information corresponds to a reference decoder NN architecture, such as type and quantity of layers of the NN (e.g., CNN with 2 layers). Similar to the first level, the UE may select a more complex reference decoder than indicated. For example, the UE may determine to increase a complexity score from a complexity score of the reference decoder, such as by going up a layer in NN complexity (e.g., CNN to transformer NN) or layer complexity (e.g., add a layer). When concurrently training the UE encoder and the reference decoder, the UE adjust weights of both the UE encoder and reference decoder to concurrently optimize both.

Training the UE encoder with a reference decoder may impose some structure on latent space (representation of z). If the Ref-Dec has less complexity compared to actual gNB-decoder the reference decoder may actually cause a performance bottleneck during operation due to performance limits imposed during training. When the reference decoder has more complexity compared to actual network decoder, the actual network decoder will be the bottleneck. As this is an actual limitation, performance can be increased when a more complex reference decoder is used as compared to the actual network decoder.

As yet another example, a third level (e.g. level 2) of knowledge may include working knowledge of the decoder of the network. For example, the UE may have knowledge of the second level (e.g., level 1) and have model information, such as initial weights or final weights. The weight information may include or correspond to an actual network decoder or a reference network decoder provided by the network. In such implementations, the UE may select the reference decoder based on the first level information and then may train the encoder and decoder using the received decoder weight information. In some such implementations, the UE may fix the decoder weights and only adjust the encoder weights. In some other such implementations, the UE may adjust the received decoder weights and the encoder weights.

Referring to FIG. 8A, a block diagram illustrating an example of sequential training with reference decoders according to one or more aspects is depicted. In the example of FIG. 8A, an implementation where two UE vendors or classes use the same reference decoder to train the respective, different encoders, such as described above. As illustrated, a first UE trains a first encoder type (encoder type 1) with a reference decoder having a first type, and a second UE trains a second encoder type (encoder type 2) with a reference decoder having the first type (decoder type 1).

After training of the encoders and generation of training data, a decoder can be trained by the network, as described with reference to FIGS. 3C-7. For example, the training information generated from the training of the encoders is used to train shared base station/universal base station decoder (gNB decoder or “actual” decoder) of FIG. 8B.

Referring to FIG. 8B, a block diagram illustrating an example of a decoder with preprocessing according to one or more aspects is depicted. In the example of FIG. 8B, both of the UEs of FIG. 8A are operating with the base station of FIG. 8B. Specifically, both of the UE encoders (type 1 and type 2) are operating with the actual decoder, which may be the same type as reference decode (e.g., type 1) or a different type (type 2). Alternatively, the actual decoder may be the same type, but may have a higher complexity, such as by having one or more additional layers. Each of the encoders is paired with the decoder as the corresponding training data from the first and second encoders was used to train the actual decoder.

If the reference decoder has the same complexity than actual decoder, the reference decoder may be the actual bottleneck. For example, if the reference and actual decoders are both type 1 decoders with a similar number of layers, they decoders may be classified as a same complexity type.

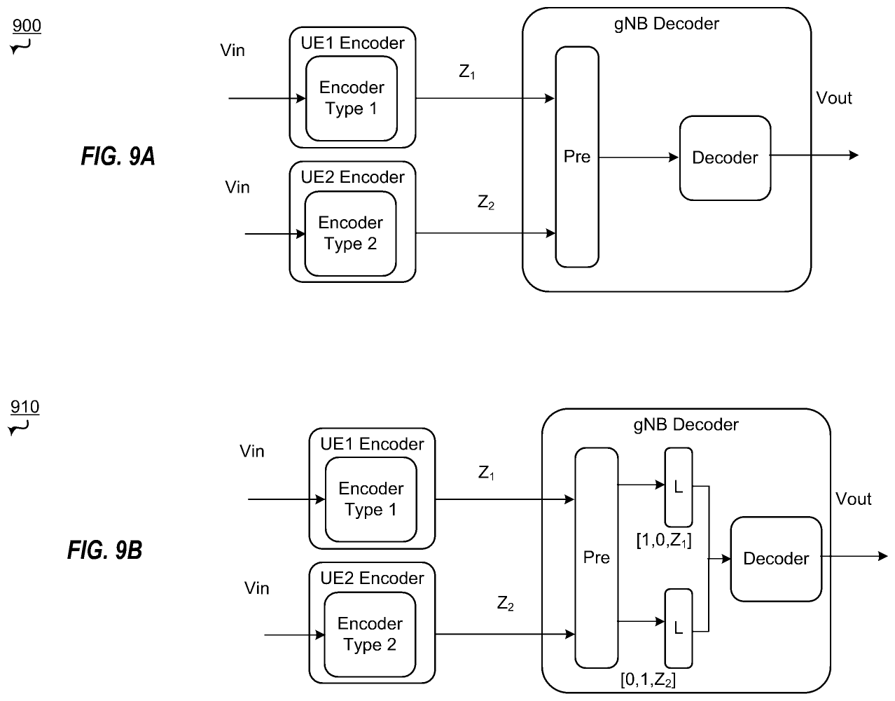

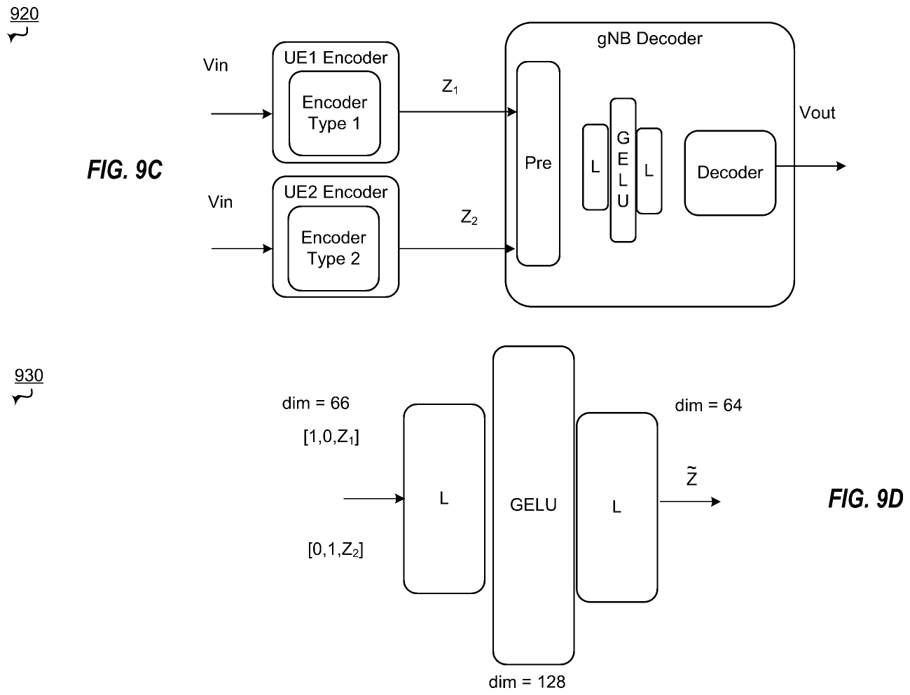

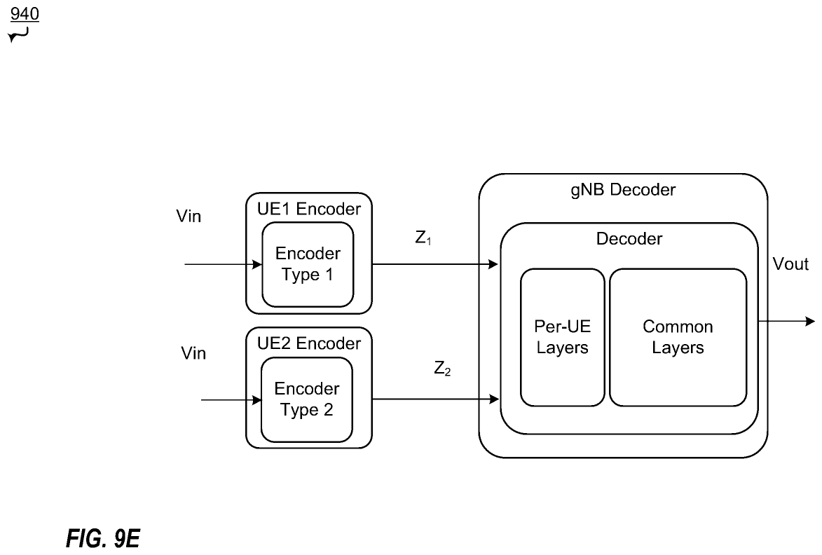

If the reference decoder has a higher complexity than actual decoder, the actual decoder will be the bottleneck. For example, if the reference decoder is a type 1 decoder and the actual decoder is a type 2 decoder, the actual decoder can be said to have a lower complexity score. Additionally, or alternatively, the actual decoder may have less layers than the reference decoder. Complexity may be based on a type of architecture, training model, layers, etc. of the decoder. Examples of different decoder architectures are illustrated in FIGS. 9A-9E.

Referring to FIG. 9A, a block diagram illustrating an example of a decoder with preprocessing according to one or more aspects is depicted. The decoder shown in FIG. 9A corresponds to a decoder with preprocessing (e.g., generic preprocessing). Preprocessing is configured to condition the input data for input to the ML, such as for input into a NN. The NN may be a simple NN, such as with one to two layers. Alternatively, the NN may be a complex NN, with 3 or more layers. As an example of preprocessing, the processing may include changing dimensions, concatenating data onto the input data for identification, conditioning, reordering the data, aligning subspaces of different inputs, rotating the data such as by multiplying, adding or subtracting. These actions may be configured to account for UE specific, encoder type specific, or vendor specific aspects which causes differences in the inputs (z).

Referring to FIG. 9B, a block diagram illustrating an example of a decoder with preprocessing according to one or more aspects is depicted. The decoder shown in FIG. 9B corresponds to a decoder with 1 hot encoding preprocessing and UE dedicated/UE specific preprocessing layers. In the example of FIG. 9B, encoder outputs, such as ZI or Z2 are received at a 1 hot encoder. The 1 hot encoder appends, adds, or concatenates one or more additional bits onto the inputs (Z1 and Z2). In a simple, single layer example, the vector Z has an original dimension of 64 bits and two bits are added as bits 0 and 1 onto a front or left end of the vector. For example, bits of 1,0 are added to Z1 and bits of 0,1 are added to Z2, and these added bits may enable identification and routing of the modified (1-hot encoded) vector corresponding to each UE (e.g., each UE type or each UE vendor) to a corresponding processing layer. Each corresponding processing layer is configured to restore or reduce a dimension of the UE specific input back to the original dimension, (z-tilde).

Additionally, each correspond processing layer perform its own action to condition the data for ML processing. For example, if the subspaces of Z1 and Z2 are not aligned, one or more of Z1 or Z2 may be rotated to align the subspaces. To illustrate, a first subspace of Z1 may be rotated to a second subspace of Z2 or both subspaces of Z1 and Z2 may be rotated by different amounts to a standard or reference subspace. Although the output of each UE specific layer is shown as combining before being received by the decoder, Z tildes for encoder 1 and encoder 2 are not combined, but such acts more like a switch to direct the conditioned/preprocessed encoder outputs to the decoder for decoding.

Referring to FIG. 9C, a block diagram illustrating an example of a decoder with preprocessing according to one or more aspects is depicted. The decoder shown in FIG. 9C corresponds to a decoder with 1 hot encoding preprocessing and common preprocessing layers. As compared to the decoder in FIG. 9B, the decoder in FIG. 9C uses a series or set of generic layers to process/condition each encoder output for input into the decoder. One example arrangement of common preprocessing layers is illustrated in FIG. C, and this example arrangement is shown in detail and described further with reference to FIG. 9D.

The common preprocessing layers of FIG. 9C may be configured to reduce or restore the input vector back to its original dimensions. For example, the 1-hot encoding may add 1 or more bits to a length of a vector or a dimension of a matrix. The common preprocessing layers may be configured to restore (e.g., reduce) the original dimension of Z. As illustrated in the prior example, 1-hot encoding adds two bits and changes the dimension from 64 to 66. The common preprocessing layers are configured to output a Z tilde with a 64 bit length. In some implementations, the common preprocessing layers may also be configured to convert each input to a reference orientation or subspace.

Referring to FIG. 9D, a block diagram illustrating an example of common preprocessing layers of a decoder according to one or more aspects is depicted. In FIG. 9D, an example of the common preprocessing layers of FIG. 9C are shown in greater detail. As illustrated, FIG. 9D includes three common preprocessing layers. The three layers include a gaussian layer sandwiched between a first linear layer and a second linear layer. As an illustrative example, the first linear layer may be configured to receive an output of a 1-hot encoder and the Gaussian layer (e.g., Gaussian Error Linear Unit (GELU) activation layer) may be configured to receive an output of the first linear layer. The second linear layer may be configured to receive an output of the Gaussian layer and to provide (output) an input to the shared common decoder.

In a particular implementation, the first layer may adjust or align the input vector which has been 1-hot encoded. In some implementations, the first linear layer and/or the gaussian layer is configured to further increase a dimension of the inputs vector, such as from 66 to 128. Additionally, or alternatively, the gaussian activation layer and/or the second linear layer is configured to reduce the dimension of the modified vector, such as from 128 to 64.

Referring to FIG. 9E, a block diagram illustrating an example of a split-architecture decoder according to one or more aspects is depicted. The decoder shown in FIG. 9E corresponds to a decoder without dedicated, separate preprocessing. Rather, the decoder has a split architecture and includes one or more per UE processing layers and one or more common processing layers (e.g., universal or non-UE specific layers). The decoder may also store per UE parameters in a memory (e.g., a decoder memory) for use with the one or more per UE processing layers. In a particular implementation, the decoder has a corresponding UE specific parameter for each UE specific layer. Processing inputs (Z) at the one or more per UE processing layers with the UE specific parameters enables the decoder to account for deviations in inputs or formats from encoder to encoder (UE to UE).

As compared to the prior decoders, the split architecture decoder of FIG. 9E maintains the same computational complexity with an increase in memory requirement for storing per-UE parameters for the per UE layers. For example, the split architecture decoder may have the name number of operations. The decoder or base station may need to store a plurality of weights, such as a product of a quantity of UEs multiplied by a quantity of parameters.

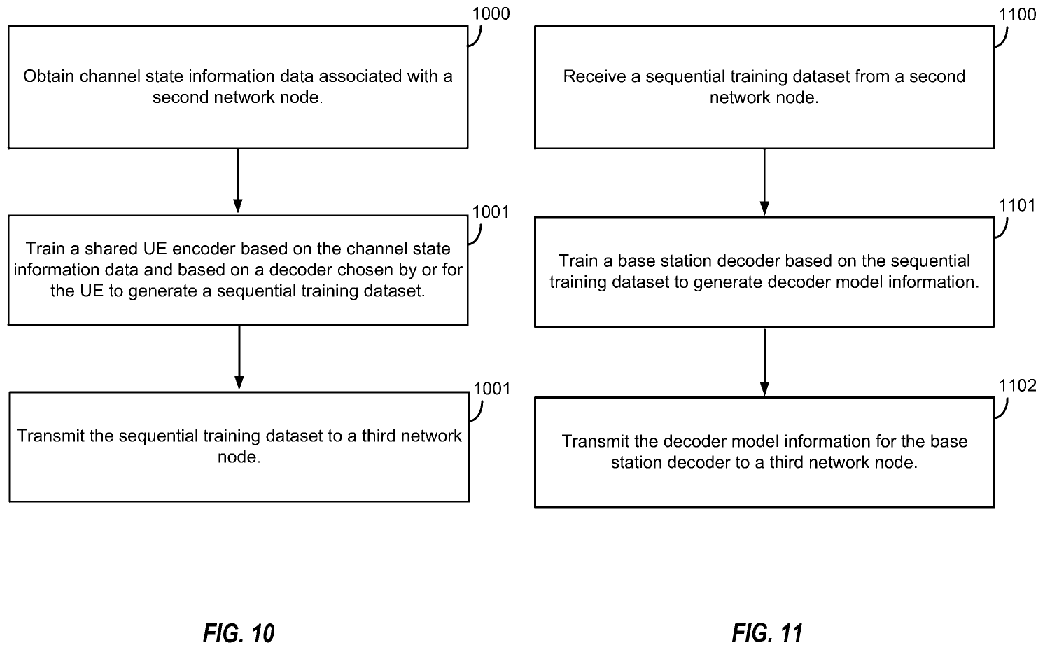

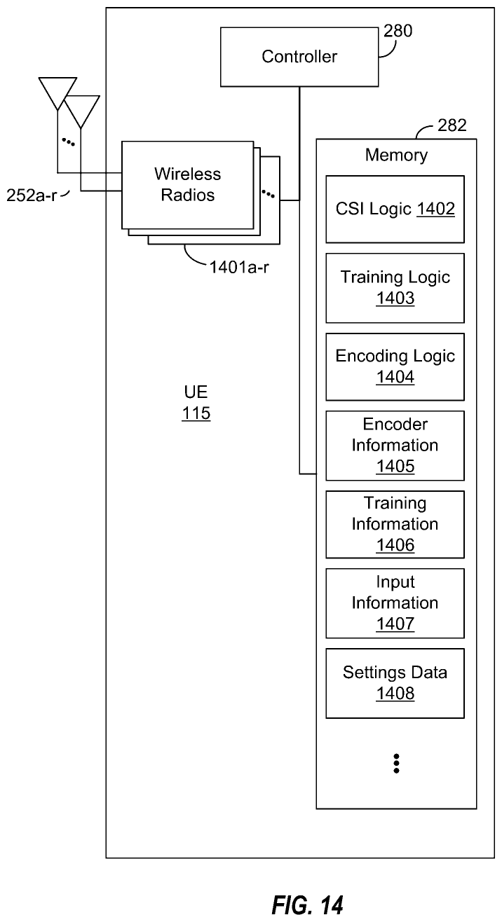

FIG. 10 is a flow diagram illustrating example blocks executed by a wireless communication device (e.g., a UE or base station) configured according to an aspect of the present disclosure. The example blocks will also be described with respect to UE 115 as illustrated in FIG. 14. FIG. 14 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1401a-r and antennas 252a-r. Wireless radios 1401a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 14, memory 282 stores CSI logic 1402, training logic 1403, encoding logic 1404, encoder information 1405, training information 1406, input information 1407, and settings data 1408. The data (1402-1408) stored in the memory 282 may include or correspond to the data (406, 408, 442, and/or 444) stored in the memory 404 of FIG. 4.

At block 1000, a wireless communication device, such as a UE side device, obtains channel state information data associated with a second network node. For example, the UE 115 or the UE-side server 120a may generate and/or receive the CSI information, as described with reference to FIGS. 4-7.

At block 1001, the UE trains a shared UE encoder based on the channel state information data and based on a decoder to generate a sequential training dataset. For example, the UE 115 or the UE-side server 120a may train a shared UE encoder based on the channel state information and based on a decoder chosen by or for the UE to generate a sequential training dataset, as described with reference to FIGS. 4-7.

At block 1002, the UE transmits the sequential training dataset to a third network node. For example, the UE 115 or the UE-side server 120a may transmit the sequential training dataset to a base station side node, as described with reference to FIGS. 4-7. Alternatively, the UE server may transmit the sequential training dataset to another UE server for aggregation before transmission to the base station side node.

The wireless communication device (e.g., UE or base station) may execute additional blocks (or the wireless communication device may be configured further perform additional operations) in other implementations. For example, the wireless communication device (e.g., the UE 115) may perform one or more operations described above. As another example, the wireless communication device (e.g., the UE 115) may perform one or more aspects as presented below.

In a first aspect, the sequential training dataset comprises a UE driven sequential training dataset configured to enable sequential training of a decoder based on concurrent training of the UE encoder and decoder.

In a second aspect, alone or in combination with the first aspect, the sequential training dataset comprises (z, Vin), wherein Vin comprises input vectors for the encoder, and wherein z comprises an output from the encoder based on Vin.

In a third aspect, alone or in combination with one or more of the above aspects, the sequential training dataset comprises (z, Vout), wherein z comprises a decoder input, and wherein Vout comprises a decoder output of vectors.

In a fourth aspect, alone or in combination with one or more of the above aspects, the channel state information data (and/or Vin?) includes or corresponds to precoder vectors or channel vectors.

In a fifth aspect, alone or in combination with one or more of the above aspects, the channel state information data (and/or Vin?) comprises raw channels or singular vectors (e.g., perturbed vectors).

In a sixth aspect, alone or in combination with one or more of the above aspects, Vin comprises uncompressed/raw channel state feedback (CSF), wherein z comprises compressed CSF, and wherein Vout comprises reconstructed/decompressed CSF, and the first network node further: encodes Vin using the shared UE encoder to generate Z; decodes Z using a reference decoder to generate Vout; compares Vout to Vin; and adjusts the encoder, the decoder or both based on the comparison.

In a seventh aspect, alone or in combination with one or more of the above aspects, to adjust the encoder, the decoder or both based on the loss function comparison includes to :calculate a gradient based on the comparison; and adjust encoder model weights, decoder model weights or both based on the gradient.

In an eighth aspect, alone or in combination with one or more of the above aspects, to obtain the channel state information data associated with the second network node includes: receive the channel state information data from the second network node; or generate the channel state information data based on communicating with the second network node.

In a ninth aspect, alone or in combination with one or more of the above aspects, the first network node comprises a UE server.

In a tenth aspect, alone or in combination with one or more of the above aspects, the second network node comprises a UE, and wherein the third network node comprises a base station server.

In an eleventh aspect, alone or in combination with one or more of the above aspects, the network node further: receives second channel state information data associated with a fourth network node (e.g., second UE); and generates aggregate channel state information based on the channel state information and the second channel state information, where to train the shared UE encoder based on the channel state information includes to: train the shared UE encoder based on the aggregate channel state information.

In a twelfth aspect, alone or in combination with one or more of the above aspects, the first network node further: receives second channel state information data associated with a fourth network node (e.g., second UE); train the shared UE encoder based on the second channel state information to update the sequential training dataset and generate an updated sequential training dataset; and transmit the updated sequential training dataset.

In a thirteenth aspect, alone or in combination with one or more of the above aspects, to train the shared UE encoder includes to: perform training (e.g., concurrent training) of the shared UE encoder and a decoder to generate the sequential training dataset and encoder model weights; and transmit the encoder model weights to the second network node.

In a fourteenth aspect, alone or in combination with one or more of the above aspects, the decoder corresponds to a reference decoder for a base station, wherein the network node further determines a type of the reference decoder based on a type of the UE encoder.

In a fifteenth aspect, alone or in combination with one or more of the above aspects, the network node further determines the type of the reference decoder based on a type or architecture of the shared UE encoder.

In a sixteenth aspect, alone or in combination with one or more of the above aspects, the decoder corresponds to a reference decoder for a base station, and the network node further: obtains reference decoder information for a base station; and determines a reference decoder based on the reference decoder information for the base station.

In a seventeenth aspect, alone or in combination with one or more of the above aspects, the decoder corresponds to a reference decoder for a base station, wherein the network node further: obtains reference decoder information and decoder model weights for a decoder of a base station, wherein the decoder model weights include initial weights or final weights; and determines the reference decoder based on the reference decoder information for the base station, wherein the shared UE encoder is trained further based on the decoder model weights.

In some such aspects, the initial weights enable the UE server to fine tune and update the weights of the decoder as well. Final weights are not updated by the UE-server.

In an eighteenth aspect, alone or in combination with one or more of the above aspects, the network node further transmits the sequential training dataset to a fourth network node.

In a nineteenth aspect, alone or in combination with one or more of the above aspects, the first network node comprises a UE, and to network node further transmits data to a fourth network node (e.g., a BS, such as the third node or another node) by encoding the data based on encoder model information, the encoder model information generated based on training the shared UE encoder.

In a twentieth aspect, alone or in combination with one or more of the above aspects, the encoder is a CSI encoder, and wherein encoding the data includes encoding CSI data to generate compressed CSI data.

In a twenty-first aspect, alone or in combination with one or more of the above aspects, the encoder is a precoding information encoder, and wherein encoding the data includes encoding precoding information to generate compressed precoding information.

In a twenty-second aspect, alone or in combination with one or more of the above aspects, the network node further transmits second data to a fifth network node (e.g., a second BS) by encoding the second data based on the encoder model information.

In a twenty-third aspect, alone or in combination with one or more of the above aspects, the network node further: receives a CSI-RS from the fourth network node; measures the CSI-RS to generate measurement data; generates (e.g., estimates) the CSI based on the measurement data; and encodes the CSI based on the encoder.

In a twenty-fourth aspect, alone or in combination with one or more of the above aspects, the network node further: receives a CSI-RS from the fourth network node; measures the CSI-RS to generate measurement data; generates (e.g., estimates) the CSI based on the measurement data; generates precoding information based on the CSI; and encodes the precoding information based on the encoder.

Accordingly, wireless communication devices may perform UE-driven sequential training operations for wireless communication devices. By performing UE-driven sequential training encoding and decoding operations can be improved which increases throughput and reduces latency, errors and overhead.

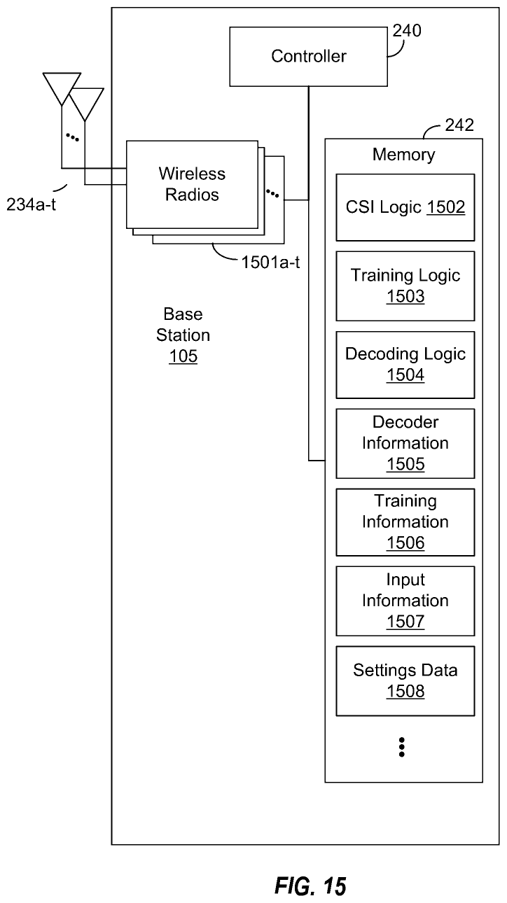

FIG. 11 is a flow diagram illustrating example blocks executed wireless communication device (e.g., a UE or network entity, such as a base station) configured according to an aspect of the present disclosure. The example blocks will be described with respect to base station 105 as illustrated in FIG. 15. FIG. 15 is a block diagram illustrating base station 105 configured according to one aspect of the present disclosure. Base station 105 includes the structure, hardware, and components as illustrated for base station 105 of FIGS. 2 and/or 4. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1501a-t and antennas 234a-t. Wireless radios 1501a-t includes various components and hardware, as illustrated in FIG. 2 for base station 105, including modulator/demodulators 232a-r, MIMO detector 236, receive processor 238, transmit processor 220, and TX MIMO processor 230. As illustrated in the example of FIG. 15, memory 242 stores logic 1502, training logic 1503, decoding logic 1504, decoder information 1505, training information 1506, input information 1507, and settings data 1508. The data (1502-1508) stored in the memory 242 may include or correspond to the data (406, 408, 442, and/or 444) stored in the memory 432 of FIG. 4.

At block 1100, a wireless communication device, such as a network device (e.g., a base station 105), receives a sequential training dataset from a second network node. For example, the base station 105 or base station-side server 120b receives training information, as described with reference to FIGS. 4-7.

At block 1101, the wireless communication device trains a base station decoder based on the sequential training dataset to generate decoder model information. For example, the base station 105 or base station-side server 120b trains a shared or universal base station decoder based on the sequential training dataset to generate decoder model parameters, as described with reference to FIGS. 4-7.

At block 1102, the wireless communication device transmits the decoder model information for the base station decoder to a third network node. For example, the base station 105 or base station-side server 120b transmits the decoder model information for the base station decoder to another BS side device, as described with reference to FIGS. 4-7. The other BS side device may be a base station (e.g., another base station) or a base station-side server (e.g., another base station-side server).

The wireless communication device (e.g., such as a UE or base station) may execute additional blocks (or the wireless communication device may be configured further perform additional operations) in other implementations. For example, the wireless communication device may perform one or more operations described above. As another example, the wireless communication device may perform one or more aspects as described with reference to FIGS. 4-8 and as presented below.

In a first aspect, the decoder model information enables other network nodes to train a shared base station decoder for decoding encoded data from multiple different types of UEs.

In a second aspect, alone or in combination with the first aspect, the network node further: receives a second sequential training dataset from a fourth network node (e.g., 2nd UE/UE Server); and generates an aggregate sequential training dataset based on the sequential training dataset and the second sequential training dataset, and where to train the base station decoder based on the sequential training dataset includes to: train the base station decoder based on the aggregate sequential training dataset to generate the decoder model information.

In a third aspect, alone or in combination with one or more of the above aspects, the network node further transmits reference decoder information to a UE or a UE server, wherein the reference decoder information enables the UE or the UE server to use the reference decoder information as a reference decoder when training a UE encoder

In a fourth aspect, alone or in combination with one or more of the above aspects, the reference decoder information comprises decoder architecture information, decoder layer information, decoder class information, or a combination thereof.

In a fifth aspect, alone or in combination with one or more of the above aspects, the decoder class information indicates decoder architecture complexity information, decoder layer complexity information, or a combined level of complexity.

In a sixth aspect, alone or in combination with one or more of the above aspects, the network node further: transmits reference decoder information and decoder model weights to a UE or a UE server, wherein the reference decoder information and the decoder model weights enable the UE or the UE server to use the reference decoder information and the decoder model weights as a reference decoder when training a UE encoder, wherein the decoder model weights include initial weights or final weights.

In a seventh aspect, alone or in combination with one or more of the above aspects, the base station decoder is more complex than any UE encoder.

In an eighth aspect, alone or in combination with one or more of the above aspects, an architecture of the base station decoder is the same type of architecture as a most complex UE encoder, and wherein the base station decoder has more layers than the most complex UE encoder.

In a ninth aspect, alone or in combination with one or more of the above aspects, the base station decoder has a substantially similar complexity to a most complex UE encoder.

In a tenth aspect, alone or in combination with one or more of the above aspects, the at base station decoder is the same type of architecture as the most complex UE encoder, and wherein the base station decoder has the same quantity of layers than the most complex UE encoder.

In an eleventh aspect, alone or in combination with one or more of the above aspects, the network node further: receives first compressed CSI from a first UE; receives second compressed CSI from a second UE; decodes the first compressed CSI to generate first decoded CSI; and decodes the second compressed CSI to generate second decoded CSI.

In a twelfth aspect, alone or in combination with one or more of the above aspects, the base station decoder comprises: a preprocessor; and a shared common decoder (e.g., universal decoder for multiple types of UEs and/or multiple vendor UEs).

In a thirteenth aspect, alone or in combination with one or more of the above aspects, the network node further: receives first UE compressed CSI from a first UE; receives second UE compressed CSI from a second UE; preprocesses, by the preprocessor, the first UE compressed CSI to generate first preprocessed CSI; preprocesses, by the preprocessor, the second UE compressed CSI to generate second preprocessed CSI; decodes, by the shared common decoder, the first preprocessed CSI to generate first decoded CSI; and decodes, by the shared common decoder, the second preprocessed CSI to generate second decoded CSI.

In a fourteenth aspect, alone or in combination with one or more of the above aspects, the preprocessor is configured to perform 1-hot encoding.

In a fifteenth aspect, alone or in combination with one or more of the above aspects, the preprocessor comprises multiple UE dedicated layers.

In a sixteenth aspect, alone or in combination with one or more of the above aspects, the network node further: receives first compressed CSI from a first UE; receives second compressed CSI from a second UE; performs, by a 1 hot encoder, 1 hot encoding on the first compressed CSI to generate first 1-hot encoded compressed CSI; performs, by the 1 hot encoder, 1 hot encoding on the second compressed CSI to generate second 1-hot encoded compressed CSI; preprocesses, by a first layer of the multiple UE dedicated layers, the first 1-hot encoded compressed CSI to generate first preprocessed CSI; preprocesses, by a second layer of the multiple UE dedicated layers, the first 1-hot encoded compressed CSI to generate second preprocessed CSI; decodes, by the shared common decoder, the first preprocessed CSI to generate first decoded CSI; and decodes, by the shared common decoder, the second preprocessed CSI to generate second decoded In a seventeenth aspect, alone or in combination with one or more of the above aspects, the preprocessor comprises a set of common processing layers.

In an eighteenth aspect, alone or in combination with one or more of the above aspects, the set of common processing layers includes: a first linear layer configured to receive an output of a 1-hot encoder; a Gaussian layer (e.g., GELU); Gaussian Error Linear Unit (GELU)) configured to receive an output of the first linear layer; and a second linear layer configured to receive an output of the Gaussian layer and to provide an input to the shared common decoder.

In a nineteenth aspect, alone or in combination with one or more of the above aspects, the network node further: receives first UE compressed CSI from a first UE; receives second UE compressed CSI from a second UE; performs, by a 1 hot encoder, 1 hot encoding on the first UE compressed CSI to generate first 1-hot encoded compressed CSI; performs, by the 1 hot encoder, 1 hot encoding on the second UE compressed CSI to generate second 1-hot encoded compressed CSI; preprocesses, by the set of common processing layers, the first 1-hot encoded compressed CSI to generate first preprocessed CSI; preprocesses, by the set of common processing layers, the first 1-hot encoded compressed CSI to generate second preprocessed CSI; decodes, by the shared common decoder, the first preprocessed CSI to generate first decoded CSI; and decodes, by the shared common decoder, the second preprocessed CSI to generate second decoded CSI.

In a twentieth aspect, alone or in combination with one or more of the above aspects, the decoder comprises a universal decoder including: one or more UE dedicated layers configured to pre-process compressed CSI based on stored per-UE parameters; one or more common layers configured to decode pre-processed CSI; and the stored per-UE parameters.

In a twenty-first aspect, alone or in combination with one or more of the above aspects, the network node further: receives first compressed CSI from a first UE; receives second compressed CSI from a second UE; processes, by the one or more UE dedicated layers, the first compressed CSI based on first stored UE parameters of the stored per-UE parameters to generate first adjusted CSI; processes, by the one or more UE dedicated layers, the second compressed CSI based on second stored UE parameters of the stored per-UE parameters to generate second adjusted CSI; decodes, by the one or more common layers, the first adjusted CSI to generate first decoded CSI; and decodes, by the one or more common layers, the second adjusted CSI to generate second decoded CSI.

Accordingly, wireless communication devices may perform UE-driven sequential training operations for wireless communication devices. By performing UE-driven sequential training encoding and decoding operations can be improved which increases throughput and reduces latency, errors and overhead.

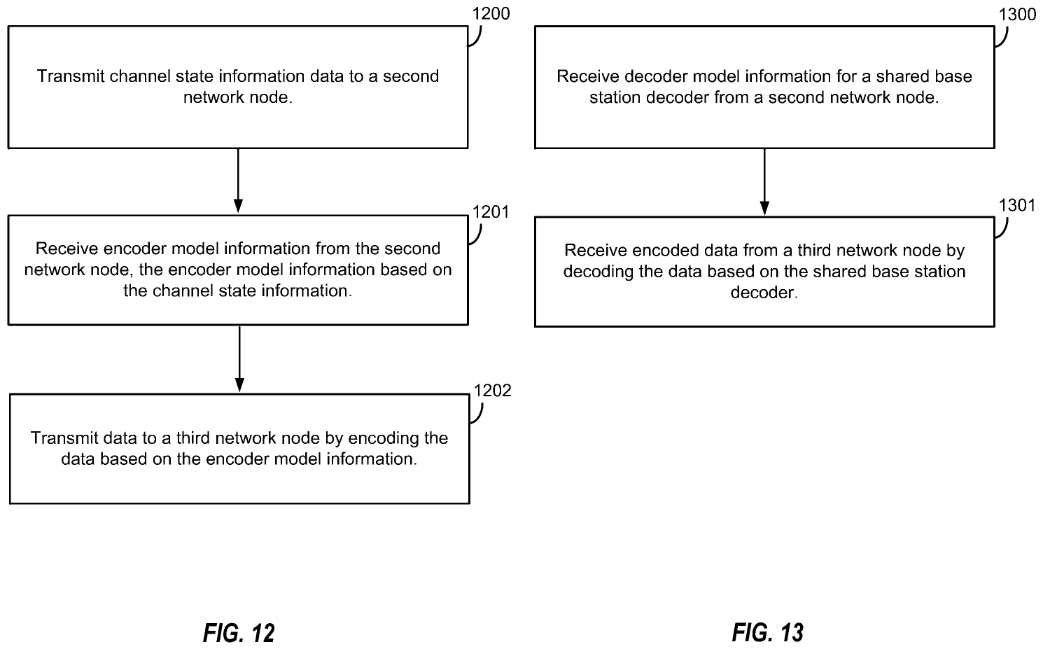

FIG. 12 is a flow diagram illustrating example blocks executed wireless communication device (e.g., a UE or network entity, such as a base station) configured according to an aspect of the present disclosure. The example blocks will also be described with respect to UE 115 as illustrated in FIG. 14 and described above.

At block 1200, a wireless communication device, such as a UE side device, transmits channel state information data to a second network node. For example, the UE 115 transmits CSI data to another node, as described with reference to FIGS. 4-7. The other node may include or correspond to a UE side device or a BS side deice. When it's a UE side device, the device may include or correspond to a UE or a UE server. When it's a BS side device, the device may include or correspond to a BS or a BS server.

At block 1201, the wireless communication device receives encoder model information from the second network node, the encoder model information based on the channel state information. For example, the UE or UE receives encoder model parameters from another UE side device, as described with reference to FIGS. 4-7.

At block 1202, the wireless communication device transmits data to a third network node by encoding the data based on the encoder model information. For example, the UE transmits encoded CSI information to a base station, as described with reference to FIGS. 4-7.

The wireless communication device (e.g., such as a UE or base station) may execute additional blocks (or the wireless communication device may be configured further perform additional operations) in other implementations. For example, the wireless communication device may perform one or more operations described above. As another example, the wireless communication device may perform one or more aspects as described with reference to FIGS. 4-7 and as presented below.

In a first aspect, the encoder is a CSI encoder, and wherein encoding the data includes encoding CSI data to generate compressed CSI data.

In a second aspect, alone or in combination with the first aspect, the encoder is a precoding information encoder, and wherein encoding the data includes encoding precoding information data to generate compressed precoding information data.

In a third aspect, alone or in combination with one or more of the above aspects, the network node further: transmits second encoded data to a fourth network node (e.g., second BS) by encoding second data based on the encoder model information, the fourth network node different from the third network node (e.g., different type of BS or vendor).

In a fourth aspect, alone or in combination with one or more of the above aspects, the first network node comprises a UE.

In a fifth aspect, alone or in combination with one or more of the above aspects, the second network node comprises a UE server, and wherein the third network node comprises a base station.

In a sixth aspect, alone or in combination with one or more of the above aspects, the channel state information data includes or corresponds to historical CSI data from the first network node communicating with one or more other nodes.

In a seventh aspect, alone or in combination with one or more of the above aspects, the channel state information data includes or corresponds to CSI data from the first network node communicating with the second network node.

In an eighth aspect, alone or in combination with one or more of the above aspects, the first network node is connected to the second network node via a non-cellular communication link (e.g., WiFi, Bluetooth, etc.), and wherein the channel state information data or the encoder model information is transmitted via the non-cellular communication link.

In a ninth aspect, alone or in combination with one or more of the above aspects, the network node further: receives a CSI-RS from the third network node; measures the CSI-RS to generate measurement data; generates (e.g., estimates) the CSI based on the measurement data; and encodes the CSI based on the encoder.

In a tenth aspect, alone or in combination with one or more of the above aspects, the network node further: receives a CSI-RS from the third network node; measures the CSI-RS to generate measurement data; generates (e.g., estimates) the CSI based on the measurement data; generates precoding information based on the CSI; and encodes the precoding information based on the encoder.

Accordingly, wireless communication devices may perform UE-driven sequential training operations for wireless communication devices. By performing UE-driven sequential training encoding and decoding operations can be improved which increases throughput and reduces latency, errors and overhead.

FIG. 13 is a flow diagram illustrating example blocks executed wireless communication device (e.g., a UE or network entity, such as a base station) configured according to an aspect of the present disclosure. The example blocks will also be described with respect to base station 105 as illustrated in FIG. 15.

At block 1300, a wireless communication device, such as a network device (e.g., a base station 105), receives decoder model information for a shared base station decoder from a second network node. For example, the base station 105 receives a decoder information, such as decoder model parameters, from another base station or from a base station server, as described with reference to FIGS. 4-7.

At block 1301, the wireless communication device receives encoded data from a third network node by decoding the encoded data based on the shared base station decoder. For example, the base station 105 receives encoded data and decodes the data using the decoder which was adjusted or trained using the decoder information, as described with reference to FIGS. 4-7. The decoder information may be generated based on UE-driven sequential information.

The wireless communication device (e.g., such as a UE or base station) may execute additional blocks (or the wireless communication device may be configured further perform additional operations) in other implementations. For example, the wireless communication device may perform one or more operations described above. As another example, the wireless communication device may perform one or more aspects as described with reference to FIGS. 4-7 and as presented below.

In a first aspect, the network node further trains the shared base station decoder based on the decoder model information.

In a second aspect, alone or in combination with the first aspect, the network node further receives second encoded data from a fourth network node (e.g., second UE) by decoding the second encoded based on the shared base station decoder, wherein the fourth network node is a different type of node from the third network node.

In a third aspect, alone or in combination with one or more of the above aspects, the first network node comprises a base station.

In a fourth aspect, alone or in combination with one or more of the above aspects, the second network node comprises a base station server, and wherein the third network node comprises a UE.

Accordingly, wireless communication devices may perform UE-driven sequential training operations for wireless communication devices. By performing UE-driven sequential training encoding and decoding operations can be improved which increases throughput and reduces latency, errors and overhead.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-15 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A first network node for wireless communication, comprising:
at least one processor; and
a memory coupled to the at least one processor,
wherein the at least one processor is configured to:
obtain channel state information data associated with a second network node;
train a shared UE encoder based on the channel state information data and based on a decoder to generate a sequential training dataset; and
transmit the sequential training dataset to a third network node.

2. The first network node of claim 1, wherein the sequential training dataset comprises a UE driven sequential training dataset configured to enable sequential training of a decoder of the third network node based on concurrent training of the shared UE encoder and the decoder at the first network node.

3. The first network node of claim 1, wherein the sequential training dataset comprises:
(z, Vin), wherein the Vin comprises input vectors for the shared UE encoder and the z comprises an output from the shared UE encoder based on the Vin; or
(z, Vout), wherein the z comprises a decoder input and the Vout comprises a decoder output of vectors.

4. The first network node of claim 1, wherein the channel state information data includes or corresponds to precoder vectors or a channel matrix.

5. The first network node of claim 1, wherein the at least one processor is configured to:
encode uncompressed or raw channel state feedback (CSF) using the shared UE encoder to generate compressed CSF; and
decode the compressed CSF using the decoder to generate reconstructed or decompressed CSF; and
compare the reconstructed or decompressed CSF to the uncompressed or raw CSF; and
adjust the shared UE encoder, the decoder or both based on the comparison.

6. The first network node of claim 1, wherein the first network node comprises a UE server, wherein the second network node comprises a UE, and wherein the third network node comprises a base station server.

7. The first network node of claim 1, wherein the at least one processor is configured to:
receive second channel state information data associated with a fourth network node; and
generate aggregate channel state information based on the channel state information data and the second channel state information data, and wherein the at least one processor is configured to train the shared UE encoder based on the channel state information data includes to:
train the shared UE encoder based on the aggregate channel state information.

8. The first network node of claim 1, wherein the at least one processor is configured to:
receive second channel state information data associated with a fourth network node;
train the shared UE encoder based on the second channel state information data to update the sequential training dataset and generate an updated sequential training dataset; and
transmit the updated sequential training dataset.

9. The first network node of claim 1, wherein the at least one processor is configured to train the shared UE encoder includes to:
perform training of the shared UE encoder and the decoder to generate the sequential training dataset and encoder model weights, and wherein the at least one processor is further configured to:
transmit the encoder model weights to the second network node.

10. The first network node of claim 1, wherein the decoder corresponds to a reference decoder for a base station, wherein the at least one processor is configured to:
determine a type of the reference decoder based on a type of the shared UE encoder.

11. The first network node of claim 10, wherein the at least one processor is configured to:
determine the type of the reference decoder based on a type or architecture of the shared UE encoder.

12. The first network node of claim 1, wherein the decoder corresponds to a reference decoder for a base station, wherein the at least one processor is configured to:
obtain reference decoder information for a base station; and
determine a reference decoder based on the reference decoder information for the base station.

13. The first network node of claim 1, wherein the decoder corresponds to a reference decoder for a base station, wherein the at least one processor is configured to:
obtain reference decoder information and decoder model weights for a decoder of a base station, wherein the decoder model weights include initial weights or final weights; and
determine the reference decoder based on the reference decoder information for the base station, wherein the shared UE encoder is trained further based on the decoder model weights.

14. The first network node of claim 1, wherein the at least one processor is configured to:
transmit the sequential training dataset to a fourth network node.

15. The first network node of claim 1, wherein the first network node comprises a UE, and wherein
transmit data to a fourth network node by encoding the data based on encoder model information, the encoder model information generated based on training the shared UE encoder.

16. The first network node of claim 15, wherein:
the shared UE encoder is a CSI encoder and encoding the data includes encoding CSI data to generate compressed CSI data; or
the shared UE encoder is a precoding information encoder and encoding the data includes encoding precoding information to generate compressed precoding information.

17. A first network node for wireless communication, comprising:
at least one processor; and
a memory coupled to the at least one processor,
wherein the at least one processor is configured to:
receive a sequential training dataset from a second network node;
train a base station decoder based on the sequential training dataset to generate decoder model information; and
transmit the decoder model information for the base station decoder to a third network node.

18. The first network node of claim 17, wherein the decoder model information enables other network nodes to train a shared base station decoder for decoding encoded data from multiple different types of UEs.

19. The first network node of claim 17, wherein the at least one processor is configured to:
receive a second sequential training dataset from a fourth network node; and
generate an aggregate sequential training dataset based on the sequential training dataset and the second sequential training dataset, and wherein the at least one processor configured to train the base station decoder based on the sequential training dataset includes to:
train the base station decoder based on the aggregate sequential training dataset to generate the decoder model information.

20. The first network node of claim 17, wherein the at least one processor is configured to:
transmit reference decoder information to a UE or a UE server, wherein the reference decoder information enables the UE or the UE server to use the reference decoder information as a reference decoder when training a UE encoder.

21. The first network node of claim 20, wherein the reference decoder information comprises decoder architecture information, decoder layer information, decoder class information, or a combination thereof.

22. The first network node of claim 21, wherein the decoder class information indicates decoder architecture complexity information, decoder layer complexity information, or a combined level of complexity.

23. The first network node of claim 17, wherein the at least one processor is configured to:
transmit reference decoder information and decoder model weights to a UE or a UE server, wherein the reference decoder information and the decoder model weights enable the UE or the UE server to use the reference decoder information and the decoder model weights as a reference decoder when training a UE encoder, wherein the decoder model weights include initial weights or final weights.

24. The first network node of claim 17, wherein the base station decoder comprises:
a preprocessor; and
a shared common decoder.

25. The first network node of claim 24, wherein the preprocessor is configured to perform 1-hot encoding.

26. The first network node of claim 24, wherein the preprocessor comprises multiple UE dedicated layers.

27. The first network node of claim 24, wherein the preprocessor comprises a set of common processing layers, and wherein the set of common processing layers includes:
a first linear layer configured to receive an output of a 1-hot encoder;
a Gaussian layer configured to receive an output of the first linear layer; and
a second linear layer configured to receive an output of the Gaussian layer and to provide an input to the shared common decoder.

28. The first network node of claim 17, wherein the base station decoder comprises a universal base station decoder including:
one or more UE dedicated layers configured to pre-process compressed CSI based on stored per-UE parameters;
one or more common layers configured to decode pre-processed CSI; and
the stored per-UE parameters.

29. A first network node for wireless communication, comprising:
at least one processor; and
a memory coupled to the at least one processor,
wherein the at least one processor is configured to:
transmit channel state information data to a second network node;
receive encoder model information from the second network node, the encoder model information based on the channel state information data; and
transmit data to a third network node by encoding the data based on the encoder model information.

30. A first network node for wireless communication, comprising:
at least one processor; and
a memory coupled to the at least one processor,
wherein the at least one processor is configured to:
receive decoder model information for a shared base station decoder from a second network node; and
receive encoded data from a third network node by decoding the encoded data based on the shared base station decoder.
